(19) United States
(12) Patent Application Publication
(10) Pub. No.: US 2026/0140009 A1
(43) Pub. Date: May 21, 2026

(54) ENVIRONMENTAL AND STRUCTURAL CONDITION MONITORING

(71) Applicant: Green Grid Inc., San Ramon, CA (US)

(72) Inventors: Chinmoy Prosun SAHA, San Ramon, CA (US); Jeffrey Scott PICKLES, Sunnyvale, CA (US)

(73) Assignee: Green Grid Inc., San Ramon, CA (US)

(21) Appl. No.: 18/948,604

(22) Filed: Nov. 15, 2024

(51) Int. Cl. G01M 5/00; H02S 99/00; H04N 7/18

(52) U.S. Cl. CPC G01M 5/0066; G01M 5/0008; H04N 7/183; H04N 7/188; G06T 2207/30184; H02S 99/00

(57) ABSTRACT

An environmental and structural condition monitoring system and method provide a sensor mounted to a structure and a camera automatically capturing and transmitting an image in response to data obtained from the sensor. Another aspect of the present system and method include an inertial measurement unit and a camera. An aspect of the present system and method employs a programmable controller which receives inclinometer, accelerometer, magnetometer, vibration, torsion, wind, temperature, humidity, methane, airborne particulate and/or impact force sensor data signals, and automatically determines if a digital image (such as a video clip) is desired based on the data signals and, if yes, automatically activates a camera adjacent the sensor and sends an alert with the sensor data and camera image to a remote receiver.

### BACKGROUND AND SUMMARY

The present application generally pertains to environmental and structural condition monitoring, and more particularly to environmental and structural condition monitoring including an inertial measurement unit and a camera.

It is known to use a camera to monitor vegetation contact with and wildfires near powerlines. Such a system is discussed in U.S. Patent Publication No. 2021/0073692 entitled “Method and System for Utility Infrastructure Condition Monitoring, Detection and Response,” which was invented by Chinmoy Saha, Jeffrey Pickles and Kourosh Jafari Khouzani, and is commonly owned with the present application, and is incorporated by reference herein. While this prior system is a significant advance in the industry, further improvements are desired to remotely detect other aspects of structures which are often otherwise difficult to access.

A traditional device uses an accelerometer mounted on a powerline to detect movement thereof. This is disclosed in U.S. Patent Publication No. 2014/0136140 entitled “Systems and Methods for Detecting Overhead Line Motion” which published to Chan, et al. on May 15, 2014, and is incorporated by reference herein. However, this traditional system merely employs a camera to acquire locations of objects nearby for mapping. The mounting of an accelerometer and associated hardware directly on a movable powerline disadvantageously adds weight and further swaying momentum to the powerline. Thus, the Chan device is very limited in what it senses and it also does not teach any automated camera control or automated image manipulation based on sensed data.

In accordance with the present invention, an environmental and structural condition monitoring system and method provide a sensor mounted to a structure and a camera automatically capturing and transmitting an image in response to data obtained from the sensor. Another aspect of the present system and method include an inertial measurement unit and a camera. An aspect of the present system and method employs a programmable controller which receives inclinometer, accelerometer, magnetometer, vibration, torsion, wind, temperature, humidity, methane, airborne particulate and/or impact force sensor data signals, and automatically determines if a digital image (such as a video clip) is desired based on the data signals and, if yes, automatically activates a camera adjacent the sensor and sends an alert with the sensor data and camera image to a remote receiver. A further aspect employs a remote central controller and/or software instructions which receive sensor data from structures such as a high voltage power transmission tower infrastructure, powerline pole infrastructure, wind turbine infrastructure, bridge infrastructure, road infrastructure, rail infrastructure, a liquid or gas holding tank structure, building structure, ship structure and airplane structure. Another aspect of the present system and method detects and senses undesired abnormal characteristics of a structure in real-time as compared to previously detected and sensed normal characteristics of the structure, to automatically determine if a potentially hazardous condition exists at or near the structure, and then automatically obtains and sends an image (such as video clips) from a camera at or adjacent the structure, and sends a warning alert to a user with the sensed abnormal data and associated image. In a further aspect, the present system employs a sensor and a camera to determine if undesired corrosion is present on a structure, and if so, send sensor data and an associated image to a remotely located user.

The present system is advantageous over conventional devices. For example, the present system automatically senses and monitors real-time movement characteristics at a difficult to access mechanical structure or adjacent area, and sends sensor data plus a camera image of the sensed area to one or more remote control centers or users which advantageously improves safety, maintenance, and operation of the structure in advance of a failure or more significant hazard. Moreover, the present system and method beneficially sense, determine and alert a user to potential hazards and problems with or near the sensed structure to provide preemptive actions to avoid wildfires, collapsing of structures, breakage due to surface irregularities, and/or reduce stresses, strains, bending, twisting, scoliosis, leaning, shaking, flutter, aeroelastic buffeting, galloping and other failure modes or disintegration of structures. The present system and method beneficially sense, determine and alert a user to potential hazards and problems with or near the sensed structure to allow preemptive actions to be taken to repair a structure after earthquakes, mudslides, ground liquification, land subsidence, erosion, rockslides, corrosion, impact forces, winds, floods, fire or the like. The present system is also advantageous by integrating multiple sensors and camera images with at least one electrical system and at least one controller to receive sensed data, make automatic determinations and report information to a control center and remote users in a fast and proactive manner. Additional advantageous and features of the present system will become apparent from the following description and appended claims, taken in conjunction with the accompanying drawings.

### BRIEF DESCRIPTION OF THE DRAWINGS

FIG. 1 is a side elevation view showing the present environmental and structural condition monitoring system;

FIG. 2 is an electrical diagram for an IMU of the present system;

FIG. 3 is an electrical diagram for a camera of the present system;

FIG. 4 is a diagrammatic view of the IMU of the present system used on a powerline tower;

FIG. 5 is a diagrammatic view of the camera of the present system used on a powerline pole and tower;

FIG. 6 is a perspective view showing the present system used on a road and bridge;

FIG. 7 is a perspective view showing the present system used on a railway;

FIG. 8 is a perspective view showing the present system used on a wind turbine;

FIG. 9 is a perspective view showing the present system used on a fluid storage tank;

FIG. 10 is a diagrammatic view showing the present system used on a building and communications tower;

FIG. 11 is a perspective view showing the present system used on a ship;

FIG. 12 is a perspective view showing the present system used on an airplane;

FIG. 13 is a partially exploded and partially fragmented perspective view showing an alternate embodiment camera and anemometer in the present system;

FIGS. 14-16 are software flow diagrams for the present system;

FIG. 17 shows camera images displayed on a graphic user interface for the present system, targeting surface corrosion on the powerline tower;

FIG. 18 shows camera images displayed on a graphic user interface for the present system, targeting surface corrosion on a metal riser of the powerline pole;

FIG. 19A shows camera images displayed on a graphic user interface for the present system, targeting surface corrosion on a base of a pole;

FIG. 19B shows camera images displayed on a graphic user interface for the present system, targeting surface corrosion on a crossarm of a powerline transmission pole;

FIG. 20 shows a sensor location map displayed on a graphic user interface for the present system;

FIG. 21 shows a sensor list displayed on a graphic user interface for the present system;

FIG. 22 shows a camera image matched with camera image data displayed on a graphic user interface for the present system;

FIGS. 23-25 show inclinometer graphs of IMU data displayed on a graphic user interface for the present system;

FIG. 26 shows a camera image and associated GUI displaying ground erosion and subsidence adjacent to a structure employing the present system;

FIG. 27 shows a camera image and associated GUI displaying scoliosis of a structure employing the present system;

FIG. 28 shows a camera image and associated GUI displaying a rock slide impacting a structure employing the present system; and

FIG. 29 is a diagrammatic view of a methane sensor employed with the present system.

### DETAILED DESCRIPTION

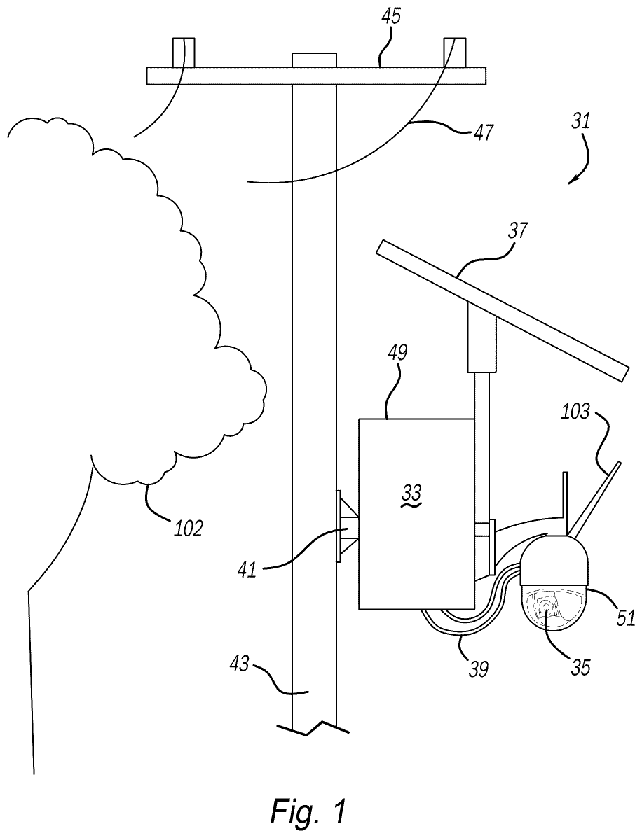

A preferred embodiment of an environmental and structural condition monitoring system 31, shown in FIGS. 1-5, includes an inertial measurement unit (“IMU”) 33 and at least one camera 35. A photovoltaic panel 37 is connected to and supplies electricity to IMU 33 and camera 35 by wires of an electrical circuit 39. One or more brackets 41 mount IMU 33, camera 35 and photovoltaic panel 37 to a structure such as a stationary and upstanding utility pole 43 or a high voltage power distribution tower 44, both of which have one or more laterally extending crossarms 45 to which powerlines 47 are attached.

In the configuration illustrated in FIG. 1, camera 35 is separate from and spaced away from a housing 49 of IMU 33. A motorized actuator moves a gimbal 51, which moves the camera in pan and tilt directions, which the camera also contains an electromagnetically moved zoom lens, or alternately two or more adjacent cameras with different preset focal lengths. At least one programmable microprocessor controller 53, located within the IMU housing 49, automatically controls activation of the gimbal and associated actuator, and automatically causes camera 35 captures digital images and/or video of a target area. Controller 53 may be on-site at the structure being monitored, or cloud-based.

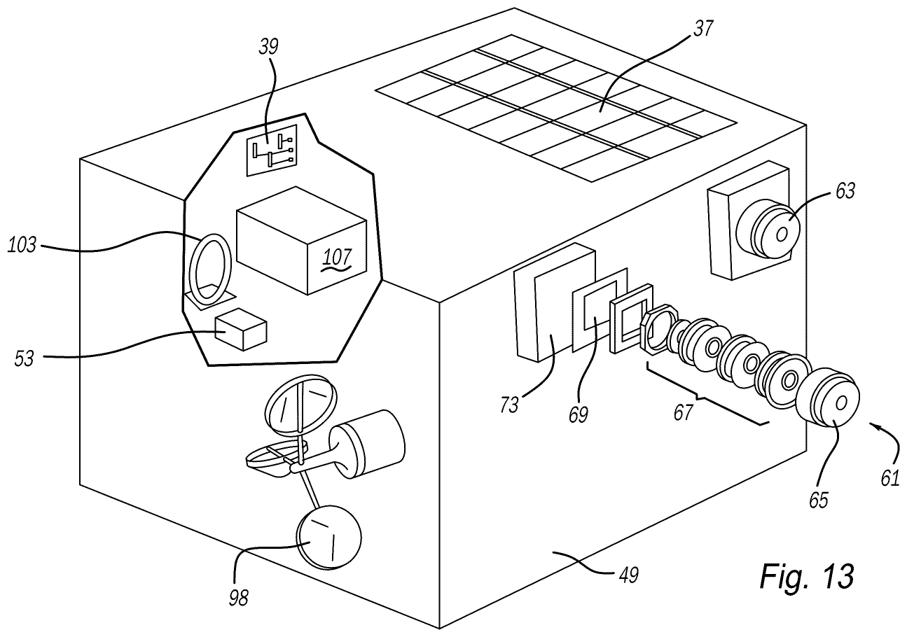

In the alternate configuration illustrated in FIG. 13, multiple cameras 61 and 63 are each stationarily coupled to IMU housing 49. Each camera has a lens cover 65, multiple stacked lenses 67, an image sensor 69, optionally a DTI, an image processor 73, and an optional image stabilizer. Each camera is preset to a different focal length and/or field of view. This embodiment also contains photovoltaic panel 37 directed attached to housing 49, electrical circuit 39, programmable controller 53, an antenna 103 inside of housing 49, and batteries 107. An anemometer (i.e., wind sensor) 98 is also coupled to an exterior of housing 49.

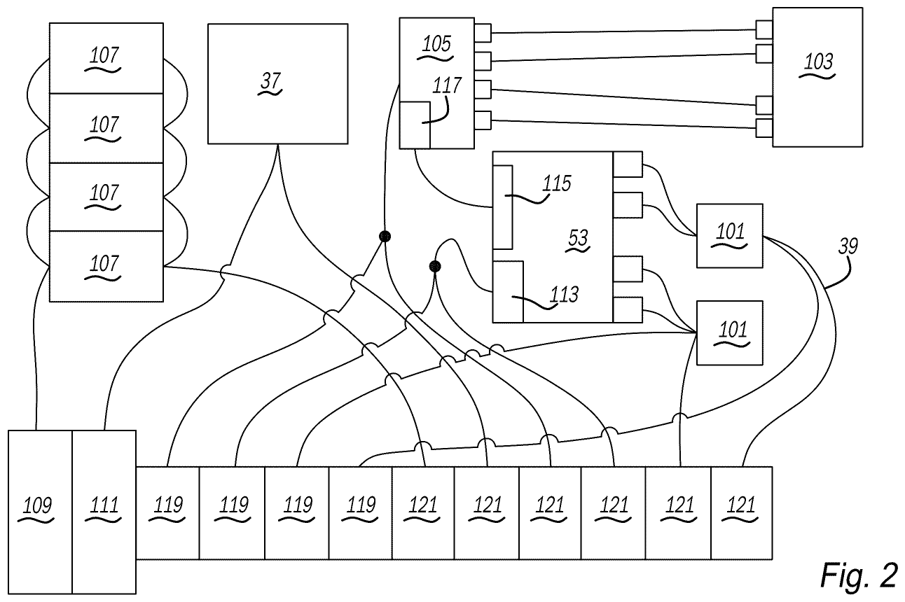

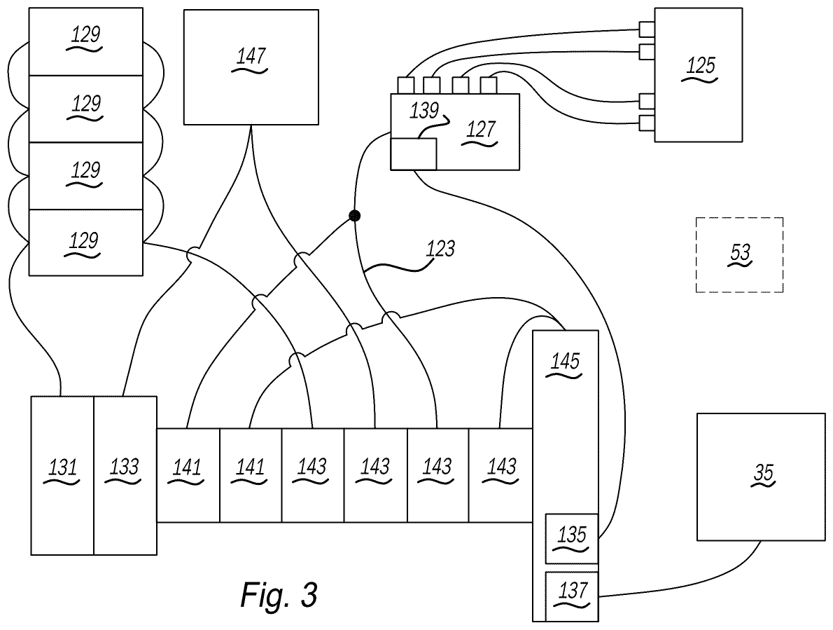

Referring to FIGS. 2 and 3, components of IMU 33 include one or more sensors 101, antenna 103, a router 105, batteries 107, a battery fuse/circuit breaker 109, a photovoltaic fuse/circuit breaker 111, a USBC port 113, an ethernet port 115, a LAN connection 117, 12-volt junctions 119, electrical ground junctions 121, in addition to controller 53, all located within the self-contained housing 49. These IMU components are electrically connected together and also to photovoltaic panel 37 and camera 35 by electrical circuit 39. In an alternate construction, the IMU sensors 101 may be separately located from controller 53 and antenna 103; for example, multiples of the sensors may be attached to upper sections of the tower or pole structure, while a single controller and antenna, connected to the sensors, are located at a base of the structure.

In one configuration, camera 35 shares the same IMU antenna 103, router 105, batteries 107, fuses/breakers 109 and 111, junctions 119 and 121, in addition to the shared controller 53 and photovoltaic panel 37. But in the alternate configuration illustrated in FIG. 3, camera 35 has its own dedicated electrical circuit 123 including an antenna 125, a router 127, batteries 129, a battery fuse/circuit breaker 131, a photovoltaic fuse/circuit breaker 133, a data port 135, a PoE port 137, a LAN connection 139, 12-volt junctions 141, electrical ground junctions 143, POE injector 145 and photovoltaic panel 147.

IMU sensors 101 include an inclinometer and optionally but preferably, also an accelerometer and magnetometer. Each IMU detects acceleration, angular velocity, 3-axis angle and magnetic field. An exemplary inclinometer, accelerometer and magnetometer unit can be obtained from Wit Motion Shenzhen Co. as model HWT905 (RS485), although other sensors may be used.

Additionally or alternately, IMU sensors may include a dedicated vibration, torsion, anemometer (wind speed), thermometer (temperature), hygrometer (humidity), methane, airborne particulate and/or impact force sensor. However, the inclinometer, accelerometer and/or magnetometer can detect many of these activities such as vibration, torsion and impact force. An exemplary weather station unit can be obtained from Hinovision Solutions LLC (dba Linovision USA) as models IOT-S300WS7 or IOT-S300WS8, although other sensors may be used. This exemplary weather sensor senses temperature, humidity, barometric pressure, wind speed and wind direction, and optionally light and precipitation.

Monitoring airborne particulates with a particle counting sensor and sending such data to the controller, allows the controller to automatically determine if an undesired and abnormal amount is sensed, and if so, the controller caused the camera(s) to capture images of the potential source of the particulates, for transmitting a matched data and image alter to end users. The source may be wildfires and their associated smoke, industrial fires, smog and pollution, volcanic ash, and the like. A wind direction and wind speed sensor(s) provide real-time data also input into the controller for the software therein to predict particulate movement patterns and concentrations. Exemplary affected end users include downwind agricultural farmers, hospitals and elderly care centers, city emergency managers, airports and the like.

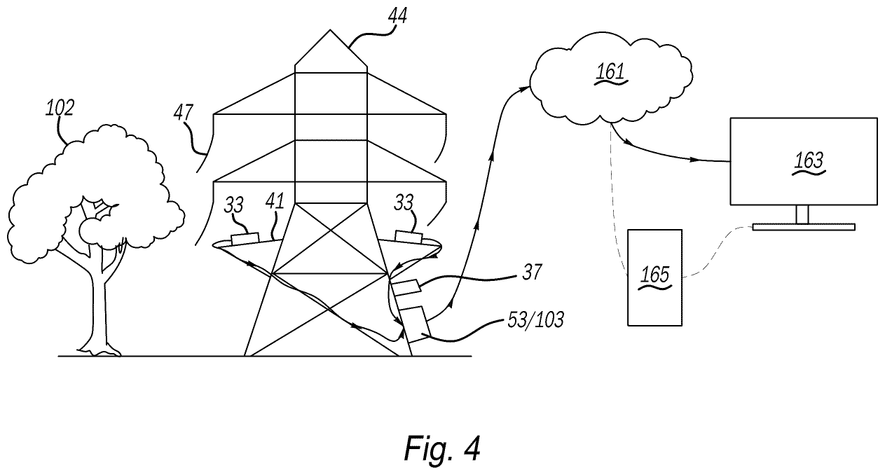

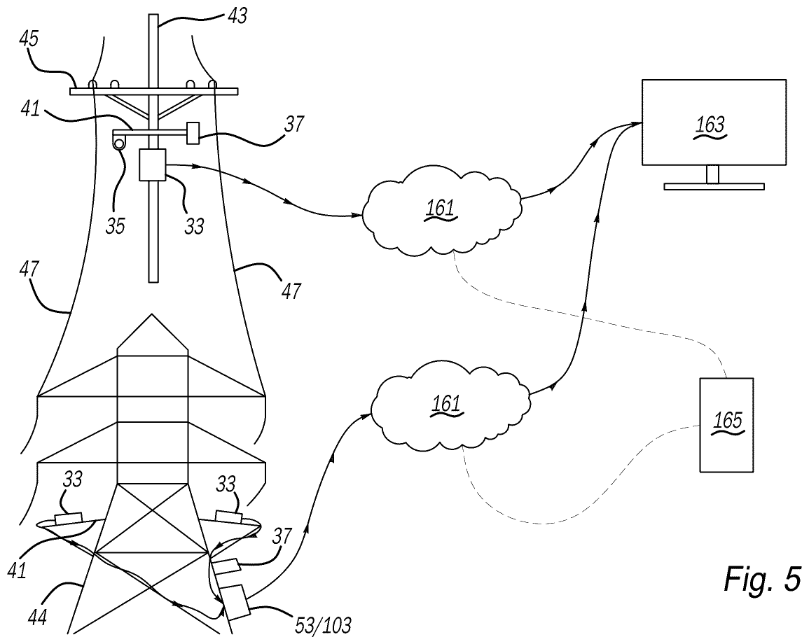

As can be observed in FIGS. 4 and 5, IMU housing 49 and its bracket 41 are preferably mounted to a side structural leg of tower 44, on a side of pole 43, or crossarm 45 attached thereto. The location of attaching the IMU sensors are determined by structural analysis of the specific infrastructure considering various parameters such as type of the host structure, prevalent failure modes, stiffness, geographic location, terrain, climatic condition, natural frequency and environmental conditions etc. Moreover, IMUs can optionally be affixed to opposite sides of an elongated structure so the controller can automatically determine if there is undesired twisting or scoliosis of the beam to which they are monitoring, be comparing the sensed IMU data from the opposite sides.

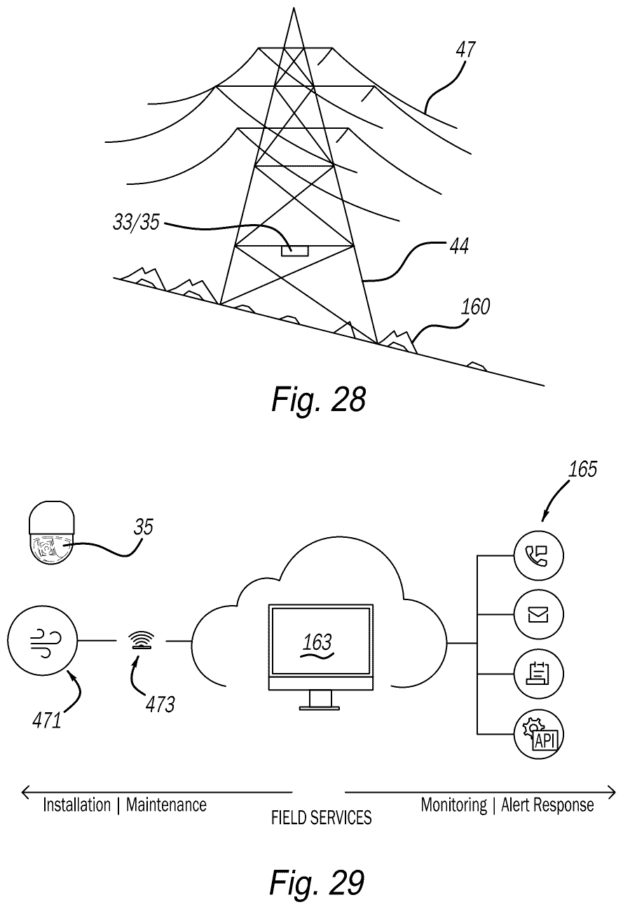

Camera units 35 are installed either on the same host infrastructure to which IMU(s) 33 are attached, or another adjacent location and connected to the same cloud system. An example of an adjacent location is mounting camera 35 to a separate and dedicated stationary pole or building structure next to the powerline tower 44 or pole 43 that has IMU 101 mounted thereto. The spaced apart but adjacent location of the camera(s) advantageously provides a view of the structure section to which the IMU is mounted, which may otherwise be partially obstructed when the camera(s) are mounted to or within the IMU housing. An alternate configuration employs one camera mounted directly to the IMU housing with at least a second camera spaced apart from but adjacent to the IMU to achieve different views. It is also envisioned that one or more cameras can capture and transmit an image of the landscape or vegetation (such as trees 102) near the pole, tower or powerline attached thereto. This adjacent area camera view is ideally suited for showing the reasons for abnormal IMU sensor output data, and shows nearby environmental activities near or contacting the structure, such as mudslides, impacts against tower 44 from rolling rocks 160 (see FIG. 28), vegetation impacts, floods, erosion and subsidence of the ground 162 adjacent a foundation 227 of tower 44 or other structure, forest fires and associated smoke, and the like. However, the direct structure camera view is ideally suited for showing twisting, bending and/or scoliosis 164 of tower 44 or other structure (see FIG. 27). The direct structure camera view is also well suited for showing surface corrosion, deformation, direct impacts and contact, breakage, and the like, with regard to the monitored structure.

In summary, the present system automatically detects, identifies and sends alerts of conditions including normal and abnormal motion, deterioration and disintegration. The IMU sensors and pan-tilt-zoom cameras are connected with a wired or wireless communication network. Furthermore, the IMU magnetometer, accelerometer and inclinometer detect heading, angles and acceleration of the section of the structure they are attached to and acquire sensed data and then the associated controller and its software analyze the sensed data with a set of optimized algorithms for detecting mechanical failure modes, such as bending, twisting, scoliosis, leaning, shaking, flutter, aeroelastic buffeting, galloping, other the like, or disintegration of individually or in combination with other sensor data, which causes the controller to automatically trigger and activate the nearby camera(s) to focus on a specific target location of or adjacent the structure, and verify the IMU detected failure mode(s) using computer vision software and associated algorithms. The camera(s) verifies the environment, such as the ground or vegetation adjacent the structure, for potential causes of failure mode corrosion, land subsidence, erosion, mud slides, rockslides, flood, wildfire, smoke from wildfires, or foreign object contact, impact force, etc. Similarly, if camera(s) detect any abnormalities, the controller and its software will automatically obtain the matching IMU data for verification of the visual detection. The IMU and camera may work in concert or less preferably, independently.

The end users receive the AI-powered alerts on their mobile and/or desktop devices via an internet or other communications connections. These alerts are used for any remedial action decision making by the users or even automatically scheduled maintenance or repair actions.

The camera images and/or videos are streamed to remote cloud storage 161 and processed with computer vision software so the IMU or a central control station programmable controller 163 can automatically detect objects of interests of or adjacent to the host structure and conditions associated to the structural conditions. A matching algorithm for specific detection is run by the IMU or central control station programmable controller to match the IMU detected condition and the camera computer vision detected condition. The IMU programmable controller or the central control station programmable controller automatically sends an alert of the sensed condition is sent to portable and handheld personal digital assistant displays 165 for remote users, with the matching IMU sensor data and camera image(s), with an automatically determined confidence level. Such remote users include maintenance and repair technicians, and/or emergency responders such as fire department personnel.

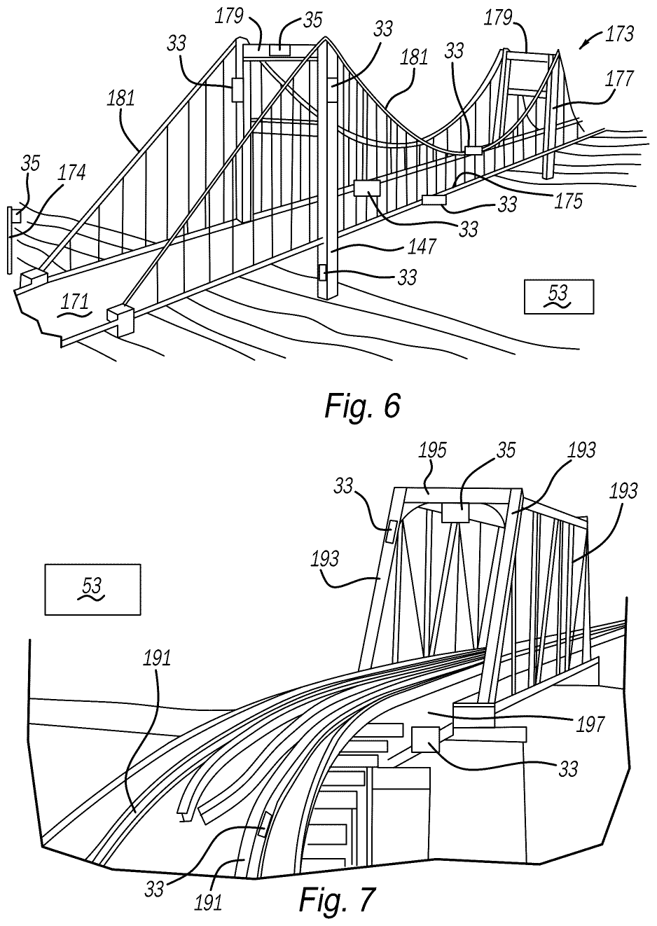

FIG. 6 shows IMUs 33 and camera(s) 35 coupled to a road structure 171 and a bridge structure 173. For road 171, one or more IMUs 33 are mounted to a side edge portion of the road with one or more associated cameras 35 each being mounted to an upstanding pole 174 spaced apart from but adjacent to a side 175 of the road, or to an overhead spanning beam 179 which may also hold traffic signs. For bridge 173, one or more IMUs 33 are mounted to upstanding pylons 177, crossbeams 179, suspension cables 181, roadways or under-supports, while cameras 35 may be coupled to any of these same structural components or to an upstanding spaced apart but adjacent pole. IMUs 33 and cameras 35 are connected to programmable controller 53 which may be inside each of the IMU housings or at a single location on the structure for use with all of the sensors and cameras.

FIG. 7 shows IMUs 33 and camera(s) 35 coupled to a railroad track 191 and an associated rail bridge structure. One or more IMUs 33 are mounted to a side of each of rails 191, upstanding beams 193, crossbeams 195, or under-supports 197, while cameras 35 may be coupled to any of these same structural components or to an upstanding spaced apart but adjacent pole. IMUs 33 and cameras 35 are connected to programmable controller 53 which may be inside each of the IMU housings or at a single location on the structure for use with all of the sensors and cameras.

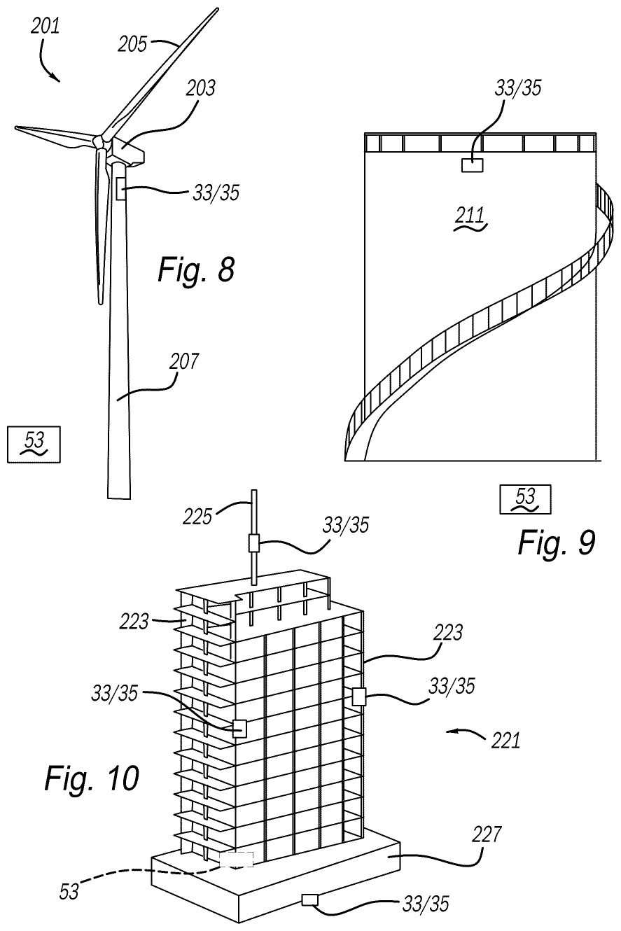

FIG. 8 shows IMUs 33 and camera(s) 35 coupled to a wind turbine structure 201 having a generator 203, rotating blades 205 and an upstanding and stationary tower 207, which are made of metallic and/or composite materials. One or more IMUs 33 are coupled to a side of tower 207, blades 205 or a housing of generator 203, while cameras 35 may be coupled to any of these same structural components or to an upstanding spaced apart but adjacent pole. IMUs 33 and cameras 35 are connected to programmable controller 53 which may be inside each of the IMU housings or at a single location on the structure for use with all of the sensors and cameras.

FIG. 9 shows IMUs 33 and camera(s) 35 coupled to a fluid holding tank structure 211, such as a stationary fuel or chemical holding tank, made of metal. One or more IMUs 33 are coupled to a side surface of tank 211 or a bracket extending therefrom, while cameras 35 may be coupled to any of these same structural components or to an upstanding spaced apart but adjacent pole. IMUs 33 and cameras 35 are connected to programmable controller 53 which may be inside each of the IMU housings or at a single location on the structure for use with all of the sensors and cameras.

FIG. 10 shows IMUs 33 and camera(s) 35 coupled to a stationary building structure 221, such as a high-rise office, residential or industrial building. One or more IMUs 33 are mounted to steel girders 223, a communications tower or mast 225, or a foundation 227, while cameras 35 may be coupled to any of these same structural components or to an upstanding spaced apart but adjacent pole. IMUs 33 and cameras 35 are connected to programmable controller 53 which may be inside each of the IMU housings or at a single location on the structure for use with all of the sensors and cameras.

The IMUs and the controller are configured to sense and determine if there are potentially hazardous environmental effects upon the bridge, such as by automatically comparing real-time sensed data values of undesired and abnormal wind-induced vibration or movement via extreme bridge harmonic frequencies, to previously sensed or predetermined threshold values of normal bridge harmonic frequencies. In another example, the IMUs and the controller are able to sense and determine if there are potentially hazardous environmental effects upon the bridge, such as by automatically comparing real-time sensed data values of undesired and abnormal flood-induced water flow, ship-induced impact, or a rock or floating tree-induced impact vibration or movement against bases of the pylons, to previously sensed or predetermined threshold values of normal base and pylon vibration or movement. A further example is when the IMUs and the controller can sense and determine if there are potentially hazardous environmental effects upon the road or rail, such as by automatically comparing real-time sensed data values of undesired and abnormal impact-induced vibration of a rock or vehicle on the road surface or rail, to previously sensed or predetermined threshold values of normal road or rail vibration. In yet another example, the IMUs and the controller can sense and determine if there are potentially hazardous environmental effects upon the road or rail, such as by automatically comparing real-time sensed data values of undesired and abnormal temperature-induced twisting or bending of the road, bridge or rail, to previously sensed or predetermined threshold values of normal road, bridge or rail movement. Another example employs the IMUs and the controller to sense and determine if there are potentially hazardous environmental effects upon the wind turbine tower, communications tower, tank, or building girder or foundation, such as by automatically comparing real-time sensed data values of undesired and abnormal earthquake or ground subsidence-induced vibrations, twisting or bending of the of the structure, to previously sensed or predetermined threshold values of normal structure movement.

If/when the controller determines that the real-time sensed data values exceed the nominal safe threshold values, then the controller automatically activates the camera(s) to capture and transmit one or more images of the road, bridge or rail, and/or adjacent area, which are then matched with and annotated (such as with superimposed frames on a camera image surrounding target areas of interest, such as an impact location, bending location, fracture location, or the like), as part of an alert or warning message. These matched and annotated IMU data and camera images, and alert message, are received by: (a) a programmable controller at a remote central control station which displays the data and image as a graphical user interface on a display monitor connected to the central controller, and/or (b) one or more remote and portable personal digital assistant displays such as cellular telephones or the like.

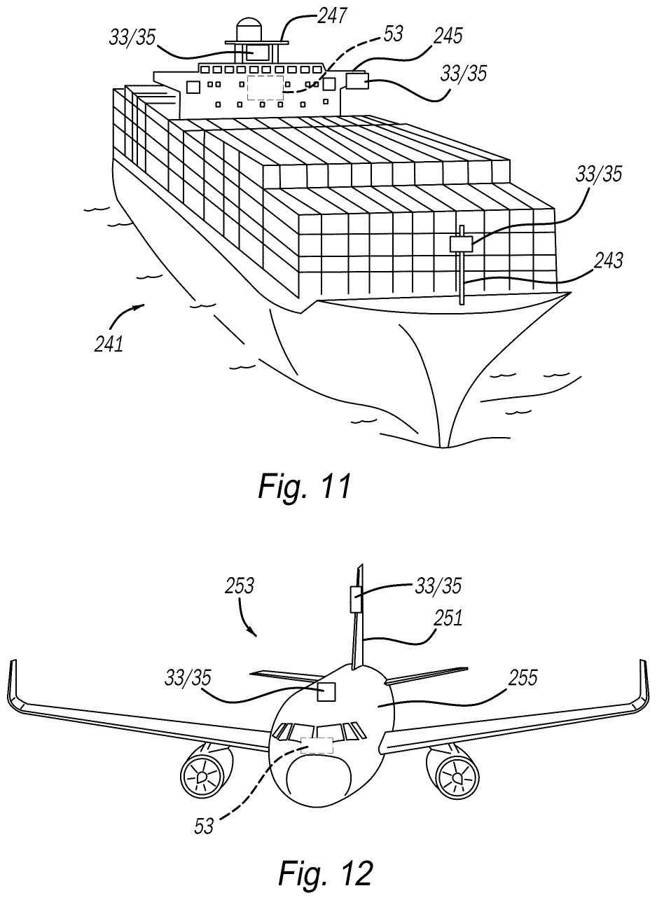

FIG. 11 shows IMUs 33 and camera(s) 35 coupled to a ship 241. One or more IMUs 33 are coupled to a mast or upstanding post 243 at a bow, an outer surface of a bridge wing 245, an outer and upper surface of a superstructure 247 of the ship, and/or other inboard or exterior location on the ship, while cameras 35 may be coupled to any of these same structural components. IMUs 33 and cameras 35 are connected to programmable controller 53 which may be inside each of the IMU housings or at a single location inside the ship's control room, for use with all of the sensors and cameras. Each IMU and the associated controller automatically detect and determine if unusual and undesired real-time sensed vibrations, motions or impacts occur in the ship, after factoring out the nominal safe vibration, motion and impact values, due to undesired shifting of cargo such as containers, excessive waves against the ship's hull, wind-induced vibration, impact against a dock or floating object, or the like. If the IMU and the controller determine that such a potentially hazardous condition has occurred, then the controller automatically activates the camera to capture images of the target area of the ship sensed by the IMU, the controller annotates the images and matches them to the sensed data, and then transmits the images/data to the central controller 53 within the ship's control room and/or at a remote location.

Referring now to FIG. 12, an IMU 33 and a camera 35 are coupled to a forward surface of an upstanding tail 251 on an aircraft, such as an airplane 253. An IMU 33 and a camera 35 may also be mounted to an upper or side surface of a fuselage 255 of airplane 253, without disturbing aerodynamic characteristics of the surfaces. This positioning allows a pilot and/or ground maintenance technician to obtain data on the ground or in flight from the IMU sensors while also viewing otherwise difficult to access surfaces of the airplane, if the IMU and a programmable controller 53, located in the cockpit, determine that an unusual and undesired vibration, motion or impact characteristic is detected. Each IMU and the associated controller automatically detect and determine if unusual and undesired real-time sensed vibrations, motions or impacts occur on the airplane, after factoring out the nominal safe vibration, motion and impact values, due to undesired shifting of cargo, excessive air turbulence, bird-induced impacts, jet turbine vibration, impact against a jetway, or the like. If the IMU and the controller determine that such a potentially hazardous condition has occurred, then the controller automatically activates the camera to capture images of the target area of the aircraft sensed by the IMU, the controller annotates the images and matches them to the sensed data, and then transmits the images/data to the central controller 53 within the cockpit and/or at a remote location.

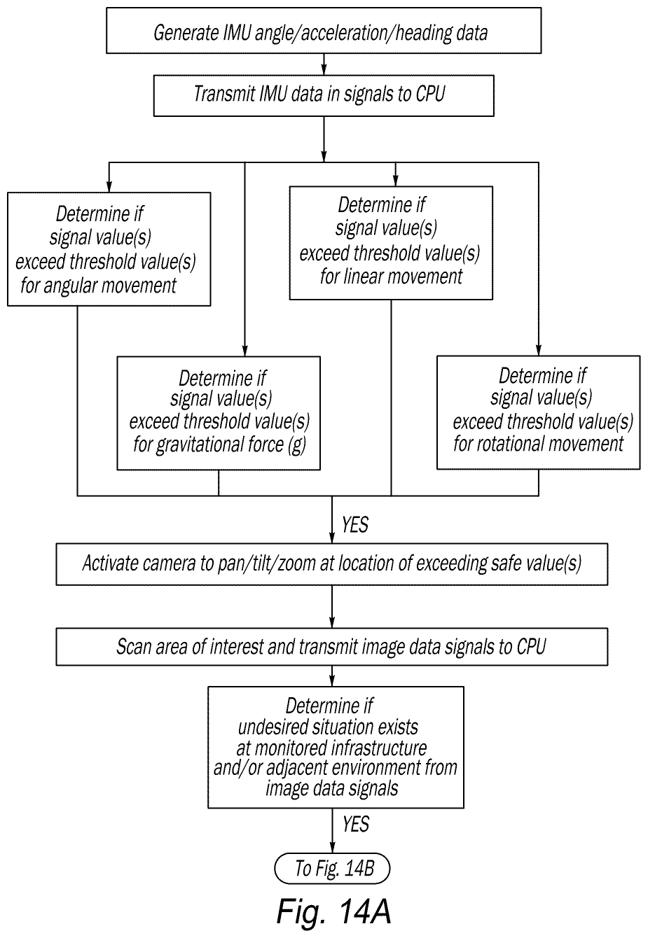

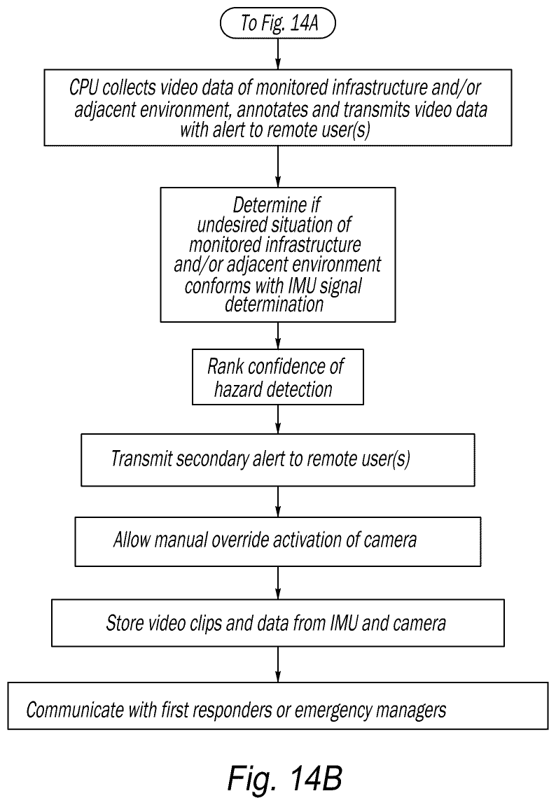

Referring to FIGS. 14A, 14B, 15 and 16, an aspect of the present system and method employs the programmable controller which receives inclinometer, accelerometer, magnetometer, vibration, torsion, wind, temperature, humidity, methane, airborne particulate and/or impact force sensor data signals, and automatically determines if a digital image is desired based on the data signals and, if yes, automatically activates one or more cameras adjacent to the sensor(s) to capture images, which the controller software annotates, and subsequently sends an alert with the sensor data and annotated camera image to a remote receiver. A further aspect employs the remote central controller and/or software instructions which receive sensor data from structures such as a high voltage power transmission tower infrastructure, powerline pole infrastructure, wind turbine infrastructure, bridge infrastructure, road infrastructure, rail infrastructure, a liquid or gas fluid holding tank structure, building structure, ship structure and airplane structure, and automatically determines if a digital image is desired based on the data signals and, if yes, automatically activates one or more cameras adjacent to the sensor(s) to capture images, which the controller software annotates, and subsequently sends an alert with the sensor data and annotated camera image to a remote receiver.

Another aspect of the present system and method detects and senses undesired abnormal characteristics of a structure in real-time as compared to previously detected and sensed normal characteristics of the structure, to automatically determine if a potentially hazardous condition exists at or near the structure, and automatically determines if a digital image is desired based on the data signals and, if yes, automatically activates one or more cameras adjacent to the sensor(s) to capture images, which the controller software annotates, and subsequently sends an alert with the sensor data and annotated camera image to a remote receiver. In a further aspect, the present system employs a sensor to determine if undesired corrosion is present on a structure, and automatically determines if a digital image is desired based on the data signals and, if yes, automatically activates one or more cameras adjacent to the sensor(s) to capture images, which the controller software annotates, and subsequently sends an alert with the sensor data and annotated camera image to a remote receiver.

More specifically, the electrical circuit connected to the programmable computer controller at the monitored structure includes internal RAM or ROM memory connected to a microprocessor. Software instructions, stored in the memory and operated by the microprocessor receive digital signals sent by the IMU and other sensors. In approximately real-time, the controller automatically compares the actual sensed data signals to previously sensed or predetermined nominal safe threshold values which are pre-stored in the memory, and then automatically determines if an undesired sensed characteristic or condition exists. If an undesired condition exists then the controller automatically causes the camera to move in pan/zoom/tilt modes in the preferred moving embodiment, or use different camera lens focal lengths if using the alternate stationary embodiment. The controller then automatically compares the images obtained based on the abnormal data to pre-stored nominal images and highlights the area(s) of concern such as by surrounding the concern area with an annotated frame and/or adding locational or sensor data on the images. Next, the controller automatically matches the annotated images to the sensed data indicating the potentially hazardous condition, and sends a signal, such as a text message, e-mail message or warning message, to a remote central control station computer controller and/or a display on a hand-held or remote cellular telephone, pager or other portable communicator and/or portable computer carried by a field technician user. The message may warn of an urgent and hazardous situation, and also optionally automatically include remedial actions such as scheduling in-person observation, maintenance or replacement of the structure or the adjacent area. This may include cutting of adjacent trees, adding dirt, rocks or buttresses to erodes ground, pumping away flood water, or the like.

Referring to FIGS. 14A and 14B, the general software instructions and method steps are as follows:
A. Generate real-time IMU angle/acceleration/heading data from sensors. Each IMU and associated camera(s) may be installed separately or as part of the same preassembled unit, however, they work in concert regardless.
B. Transmit IMU sensed data in signals to CPU controller via edge computer and/or cloud computing.
C. Determine if signal value(s) exceed threshold value(s) for angular movement, using the controller.
D. Determine if signal value(s) exceed threshold value(s) for linear movement, using the controller.
E. Determine if signal value(s) exceed threshold value(s) for gravitational force (g), using the controller using the controller.
F. Determine if signal value(s) exceed threshold value(s) for rotational movement, using the controller.
G. If the determination from the controller is a positive YES, then controller automatically activates and moves camera to pan/tilt/zoom focal points targeting locations of sensed real-time data exceeding safe and desired value(s).
H. The camera(s) scan the target area(s) of interest, capture digital images (which may be still or video images) and transmit the image data signals to the CPU or in the cloud.
I. Determine if undesired situation exists at the monitored infrastructure and/or adjacent environment from image data signals using artificial intelligence computer vision analysis, as is discussed in greater detail hereinafter.
J. If the controller determination is a positive YES, then the controller collects the camera image data of monitored infrastructure and/or adjacent environmental area, annotates the images, links and matches the image to the sensed IMU data, and then transmits the image data the controller transmits an alert or warning message to a central control station controller and/or one or more remote users, via edge or cloud computing and communications
K. Either as part of steps I and/or J before the alert transmission or after, the controller determines if the undesired situation of the monitored infrastructure and/or adjacent environment area conforms with the sensed IMU signal determination.
L. If the controller determination is a positive YES, then the controller automatically rank confidence of the sensed and determined hazard detection, for sending as part of the alert transmission of step J or later as a transmission of a secondary alert to the remote user(s).
M. The controller thereafter allow manual override activation of the camera(s) so the end user can change viewing angles or focal lengths.
N. The on-site CPU controller or the central control station controller optionally automatically stores image clips and data from the camera(s) and IMU, respectively.
O. The on-site CPU controller or the central control station controller optionally communicate with first responders or emergency managers to schedule remedial, repair or preventive action, either manually or automatically.
   If any negative NO determinations are made, then the software returns to the normal IMU sensing mode of operation and/or proceeds to another determination step.

The general software instruction and control logic method steps are also described as follows:
A. The IMU's sensed data related to angles, acceleration and/or heading are acquired continuously at certain frequencies.
B. The sensed data is sent to the cloud for automated software analysis.
C. The sensed data is automatically analyzed in the cloud for abnormalities (such as exceeding or varying from previously sensed or prestored nominal and desired threshold values) for angular movement, linear movement, rotational movement or changes in gravitational force (g).
D. If any of the parameters exceed the thresholds an alert is automatically transmitted through the internet or other communications paths to end users' mobile or desktop computers or personal digital assistants (“PDAs”), where they can be displayed on the output display screens thereof.
E. A trigger is automatically sent to the camera to pan, tilt and zoom (“PTZ”) into the location of the IMU that exceeds the threshold of a parameter.
F. The programmable camera PTZ automatically scans the areas of interest.
G. If a computer vision algorithm, run in the cloud controller or on-site controller, detects any abnormal situation within the monitored structure or its surrounding environmental area, it is programmed to focus to collect details.
H. The camera near or part of the IMU, collects video images of the location and visually ascertains he host structure's visual condition using computer vision algorithms (discussed in greater detail hereinafter).
I. If the computer vision determination detects the anomaly as indicated by the IMU, the controller automatically ranks the anomaly at a higher confidence of hazard detection.
J. The cloud controller then automatically sends an alert to the end user's devices of the hazardous situation using the internet. The alerts are text messages and emails with a description of the hazards in images and text.
K. The end users can manually use the front-end software application to look for the hazardous event by manually controlling the camera PTZ for in depth visual analysis of the situation.
L. The end users, such as first responders or emergency managers, can make remedial and/or countermeasure decisions and store video clips of the event.
   For all of the software and method steps disclosed herein, it should be appreciated that the order of some steps may vary, additional steps may be added, and some steps may be deleted, depending on the specific structure being monitored, the quantity of IMUs and camera on-site at the structure, the availability of a central control room, and other optional factors.

The IMU control algorithm and artificial intelligence software actions are set forth as follows. The presently preferred IMUs are 9-axis inclinometers that also report chip temperature, chip time and magnetic field (with respect to location on earth). The 9-axis inclinometers report Angles (in degree, for axes: x, y, z), Angular Velocity (in degree/second, for axes: x, y, z), Acceleration (in Gs (where 1 G=9.8 m/s²), for axes: x, y, z), leading to 3 readings for 3 measurements, and hence the ‘9-axis’ inclinometer. The inclinometers are connected to the controller using an RS485 USB converter for sending (T+/T−) and receiving signals (R+/R−) (also known an A+ and B− is RS485 communication protocol.)

Data from the inclinometers is retrieved in the following way:
1) First the controller sends a command to transmit data (which is also called the data request) to the slave IMU. The send command is prepended and appended by CRC low and high bytes to make it compatible with the sensor's request format.
2) The IMU receives the data transmit request and then it transmits data once per every request.
3) The data is then received by the python code running in the controller in the form of data packets in a hexadecimal format which is then converted into engineering units like angles, acceleration, magnetic field readings and angular velocity. These data packets have data from the different registers of the sensor where every register is responsible for the data pertaining to a particular measurement.
   For example: Register 0x30 is the first register; Registers 0x30 through 0x33 are responsible for reporting chip time in HH:MM:SS:MSMS and date in (DD:MM:YY) format. Registers 0x34 through 0x36 are responsible for reporting the acceleration for X, Y and Z axes. The python code is responsible for all data conversions that involve some complex binary adjustments and a plethora of conditional statement setups.
4) There are a total of three main codes running for ingesting raw data from the inclinometer and converting it into engineering units and then exporting them in the correct structure to further analyze it. The first code is for sending data requests to the IMU and then printing the data in common engineering units like: degrees, degrees/second and Gs. The second code is responsible for converting our data requests into a sensor compatible format. It also retrieves the data from the sensor and converting it into integer-based data for the first code for further use for displaying, analytics and printing purposes. The final code is used to house the threads that are responsible for driving the above two codes together, in a parallel manner so that ingestion and egestion can be ensured at the same time without any loss of time.

The basic mathematical and parameter conversions occurring inside the code are now discussed. When data readings are received from the sensor, they are in a hexadecimal format. Converting them from a hexadecimal format to an integer format involves three steps: first stripping their CRC high and low bits (these stand as tags for beginning of sequence and end of sequence in a long hexadecimal string), then conversion and then bitwise math for revealing values. All these steps then reveal that they are very big numbers like 32445 or 55422, and these numbers need to be converted into meaningful readings.

Mathematical conversions are performed as follows:
Mathematical conversion for the Angles:

$$Final Angle = Received Angle / 32768 * 180 ( repeat for all -> x y z )$$

Mathematical conversion for Acceleration:

$$Final Acceleration = Received Acceleration / 32768 * 16 ( repeat for all -> x , y , z )$$

Mathematical conversion for Angular Velocity:

$$Final\_Angular \_Velocity = Final\_Angular \_Veloicty / 32768 * 2000 ( repeat for all -> x , y , z )$$

After all these conversions, values are then fed to the first code for further human interaction and use.

Mathematical conversions for predicting Lean, Drift, and Scoliosis are as follows. Assume the sensor is in a geographical N-S configuration, connected flat-horizontally to one of the bars of the tower such that values of +x are towards the east and −x are towards the west, values of +y are towards the north and −y are towards the south, values of +z are a sign of anti-clockwise movement and −z are a sign of clockwise movement.

Lean: To calculate the lean in either x or y direction, any change in the +/−x or +/−y values is calculated. Change is calculated as follows:

$$Δ ( Delta , change ) = Current ( x / y ) value - Original ( x / y ) value$$

The sign of the delta means:
a) +Δ (X)—a value of +Δ will depict a lean along the geographical east by ‘Δ’ degrees.
b) −Δ (X)—a value of −Δ will depict a lean along the geographical west by ‘Δ’ degrees.
c) +Δ (Y)—a value of +Δ will depict a lean along the geographical north by ‘Δ’ degrees.
d) −Δ (Y)—a value of −Δ will depict a lean along the geographical south by ‘Δ’ degrees.

Drift: To calculate drift or footing, we have 8 directions to think about −N, NE, E, SE, S, SW, W, NW. Along with the directions, acceleration spikes in the +/−X or Y axes should be considered. Since the present IMU does not report linear velocity, the only way to detect/report an application of force or movement is through the spike in the acceleration.

The calculation will be as follows:
Step 1: Spike detected in +/−X or Y or both in case of a diagonal drift. Record it.
Step 2: Calculate the resultant:
   ‘a’ Resultant=√(a_x\hat{ }2+a_y\hat{ }2) (where a_x, a_y are the delta (change) in acceleration from original/inertial position).
   Given the ‘a’ resultant, you can find out the total acceleration spike in a definite direction. Angle can also be calculated on the basis of the following formula w.r.t x:

$$θ = arctan ( a\_y / a\_x ) ( Theta will help calculate the azimuth . )$$

Drift and its direction can be found using the two values.

Scoliosis: Scoliosis is the phenomenon where the towers begin to twist on itself, along its z axis. This can be measured by the change in the readings of the Z angle as returned by the IMU. The calculation is done as follows:

$$Δ ( Delta , change ) = Current angle ( z ) value - Original angle ( z ) value$$

The sign of the delta means:
a) +Δ (Z)—a value of +Δ will depict a clockwise rotation along the central axis by ‘Δ’ degrees, representing a positive torsion.
b) −Δ (Z)—a value of −Δ will depict an anticlockwise rotation along the central axis by ‘Δ’ degrees, representing a negative torsion.
   It is noteworthy that angular velocity on the cost of computational efficiency is factored into the measurement of lean/tilt, and scoliosis.

Vibration: Vibration can be measured by change in the acceleration along the X, Y, or Z axis. Calculation will be done based on count of spikes in X, Y or Z per second, as follows:

$$V ( Hz ) = No . of spikes / second$$

Where the term “spikes” refers to significant acceleration changes that surpass a threshold, minor fluctuations may not represent true vibration events.
Natural Frequency: is often determined by the rate at which a structure oscillates freely after being disturbed. The present IMU does not directly calculate natural frequency, but it can estimate it based on periodic oscillations in angle or acceleration.

The detailed software and controller steps using the algorithm include:
(A) Initialize System: Set up the cloud and/or central controller as the master device and set up the IMU's controller as the slave device. Connect the IMU using the RS485-to-USB converter.
(B) Main Program Flow:
1. Send Data Request:
   The controller sends a data request command to the IMU.
   Prepend and append CRC low and high bytes to make the command compatible with the IMU's request format.
2. IMU Response:
   The IMU receives the data request.
   The IMU transmits data in response, once per each request.
3. Receive and Process Data on Controller:
   Receive the data packets in hexadecimal format.
   Convert the data packets into the engineering units.
4. Parse Data Packets:
   Initialize ‘tempReg’ to 0x30 (starting register).
   Set a variable for the number of registers based on data packet length (e.g., NRegs).
   Initialize ‘tempVals’ as an empty array for temporary storage of values.
   For each register in the data packet (loop over ‘NRegs’).
   Calculate ‘tempIndex’ based on the register position (as a counter).
   Convert the two bytes at ‘tempIndex’ to a single value ‘tempVal.’
   Check the register address (‘tempReg’) and process data based on register range.
   ** Registers 0x30 to 0x33** (Chip Time and Date):
Append ‘tempVal’ to ‘tempVals’
   If ‘tempReg’ is 0x33 (last register for chip time):
Extract the chip time and date:

$$' \_year ' = 2000 + ( tempVals [ 0 ] \& 0 \times ff )$$

$$' \_month ' = ( tempVals [ 0 ] >> 8 ) \& 0 \times ff$$

$$' \_day ' = tempVals [ 1 ] \& 0 \times ff$$

$$' \_hour ' = ( tempVals [ 1 ] >> 8 ) \& 0 \times ff$$

$$' \_minute ' = tempVals [ 2 ] \& 0 \times ff$$

$$' \_second ' = ( tempVals [ 2 ] >> 8 ) \& 0 \times ff$$

$$' \_millisecond ' = tempVals [ 3 ]$$

Format and set “Chiptime” in ‘deviceModel’
Clear ‘tempVals’
   ** Registers 0x34 to 0x36** (Acceleration X, Y, Z):
Calculate ‘tempVal’ as ‘tempVal/32768.0*self.accRange’
Adjust for signed range if ‘tempVal>=self.accRange’
Append the calculated acceleration value to ‘tempVals’
   If ‘tempReg’ is 0x36 (last register for acceleration):
Set “accX”, “accY”, “accZ” in ‘deviceModel’ with ‘tempVals’
Clear ‘tempVals’
   **Register 0x40** (Temperature):
Calculate ‘temperature’ as ‘tempVal/100.0’ and round to two decimal places
Set “temperature” in ‘deviceModel’
   **Registers 0x37 to 0x39** (Gyroscope X, Y, Z):
Calculate ‘tempVal’ as ‘tempVal/32768.0*self.gyroRange’
Adjust for signed range if ‘tempVal>=self.gyroRange’
Append the calculated gyroscope value to ‘tempVals’
   If ‘tempReg’ is 0x39 (last register for gyroscope):
Set “gyroX”, “gyroY”, “gyroZ” in ‘deviceModel’ with ‘tempVals’
Clear ‘tempVals’
   **Registers 0x3D to 0x3F** (Angle X, Y, Z):
Calculate ‘tempVal’ as ‘tempVal/32768.0*self.angleRange’
Adjust for signed range if ‘tempVal>=self.angleRange’
Append the calculated angle value to ‘tempVals’
   If ‘tempReg’ is 0x3F (last register for angle):
Set “angleX”, “angleY”, “angleZ” in ‘deviceModel’ with ‘tempVals’
Clear ‘tempVals’
   ** Registers 0x3A to 0x3C** (Magnetometer X, Y, Z):
Append ‘tempVal’ rounded to an integer to ‘tempVals’
   If ‘tempReg’ is 0x3C (last register for magnetometer):
Set “magX”, “magY”, “magZ” in ‘deviceModel’ with ‘tempVals’
Clear ‘tempVals’
Increment ‘tempReg’ to point to the next register.
5. Convert Data to Engineering Units:
   For each parameter (angle, acceleration, angular velocity):
Strip the CRC high and low bytes.
Convert the hexadecimal data to integer values.
   Apply the mathematical conversions based on the parameter:

$$Angle : Final\_Angle = Received\_Angle / 32768 * 180 ( for x , y , z )$$

$$Acceleration : Final\_Acceleration = Received\_Acceleration / 32768 * 16 ( for x , y , z )$$

$$Angular Velocity : Final\_Angular \_Velocity = Received\_Angular \_Veloicty / 32768 * 2000 ( for x , y , z ) .$$

6. Handle Data Output:
   Data received from protocol_resolver or second code can be formatted to make rolling plots for better insights.
   Store data from TempVals as read for the Registers into a dictionary for further use.
   Data can be used to do further analysis as follows:
Lean Calculation: Calculate the lean in either the X or Y direction by monitoring changes in +/−X or +/−Y values.
   Calculate Δ (change) as:

$$delta\_x = current\_x - original\_x$$

$$delta\_y = current\_y - original\_y$$

Interpret the sign of Δ and trigger an alert if the change exceeds a threshold (e.g., 5 degrees):
Set lean_threshold to 5-Define threshold for lean alert
   If delta_x is greater than lean threshold:
Display “Alert: Leaning towards East by delta_x degrees.”
   Else if delta_x is less than negative lean threshold:
Display “Alert: Leaning towards West by absolute value of delta x degrees.”
   If delta y is greater than lean threshold:
Display “Alert: Leaning towards North by delta y degrees.”
   Else if delta y is less than negative lean threshold:
Display “Alert: Leaning towards South by absolute value of delta y degrees.”
   Drift Calculation:
Set drift threshold to 2.0—Define threshold for drift alert since there is always noise and movement due to wind.
Calculate a resultant as the square root of (a_x\hat{ }2+a_y\hat{ }2).
Calculate theta as arctangent of (a_y/a_x), in degrees.
   If ‘a’ resultant is greater than drift threshold:
If theta is between 0 and 22.5 degrees or between 337.5 and 360 degrees:
Set direction to “East.”
   Else if theta is between 22.5 and 67.5 degrees:
Set direction to “Northeast.”
   Else if theta is between 67.5 and 112.5 degrees:
Set direction to “North.”
   Else if theta is between 112.5 and 157.5 degrees:
Set direction to “Northwest.”
   Else if theta is between 157.5 and 202.5 degrees:
Set direction to “West.”
   Else if theta is between 202.5 and 247.5 degrees:
Set direction to “Southwest.”
   Else if theta is between 247.5 and 292.5 degrees:
Set direction to “South.”
   Else if theta is between 292.5 and 337.5 degrees:
Set direction to “Southeast.”
   Display “Alert: Drift detected towards [direction] with acceleration of a_resultant m/s².”
   Display “Alert: Drift detected towards [direction] with acceleration of a_resultant m/s².”
   Vibration Calculation:
Set vibration threshold to 0.1—Define threshold for vibration frequency in Hz to account for noise.
   If the vibration frequency (number of spikes per second) is greater than vibration threshold:
Display “Alert: High vibration detected at vibration frequency_Hz.”
7. End Program (if needed)
   Send final data to database or storage, if required.
   Make the graphs and use the conditional statements in the transmitted dictionary to print word-based alerts.
   Terminate threads and clean up.

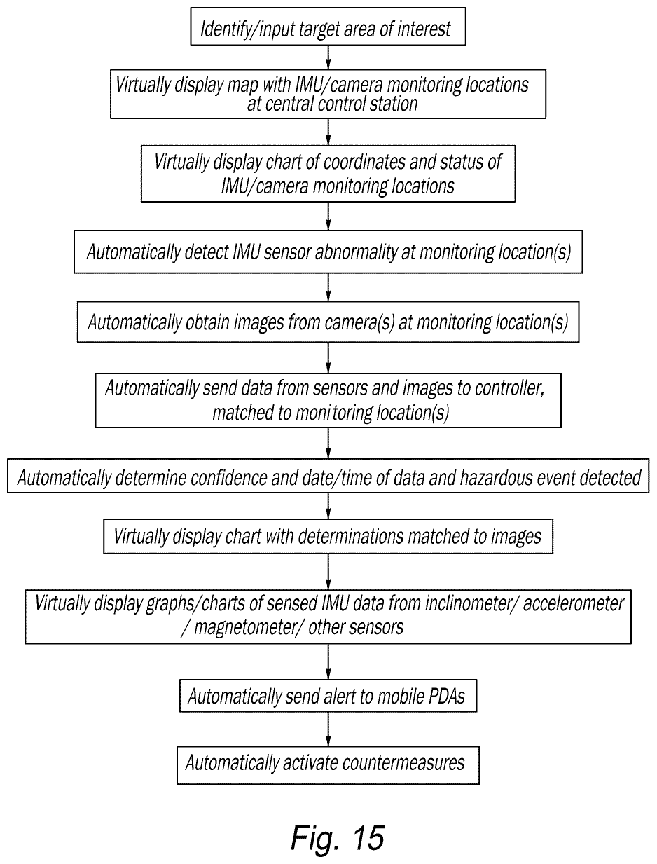

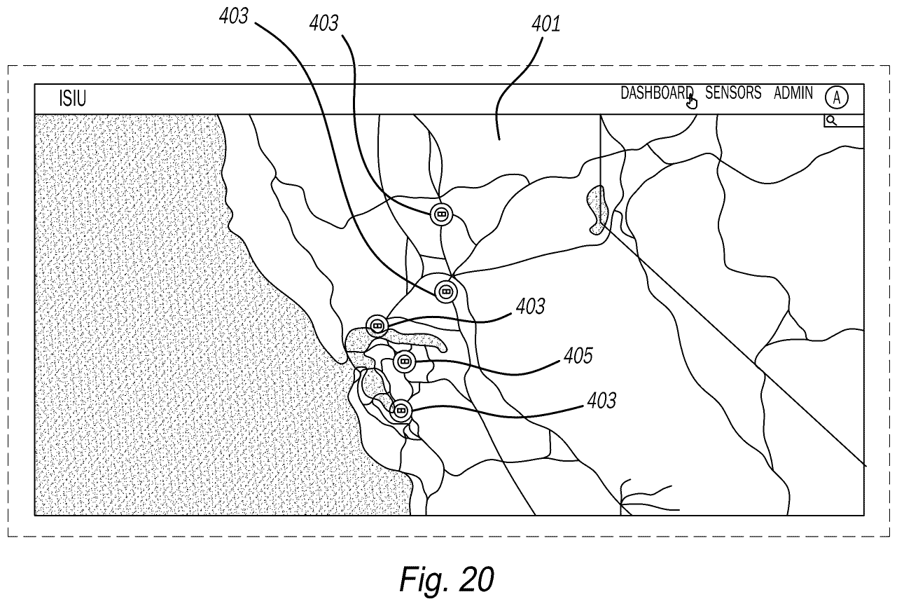

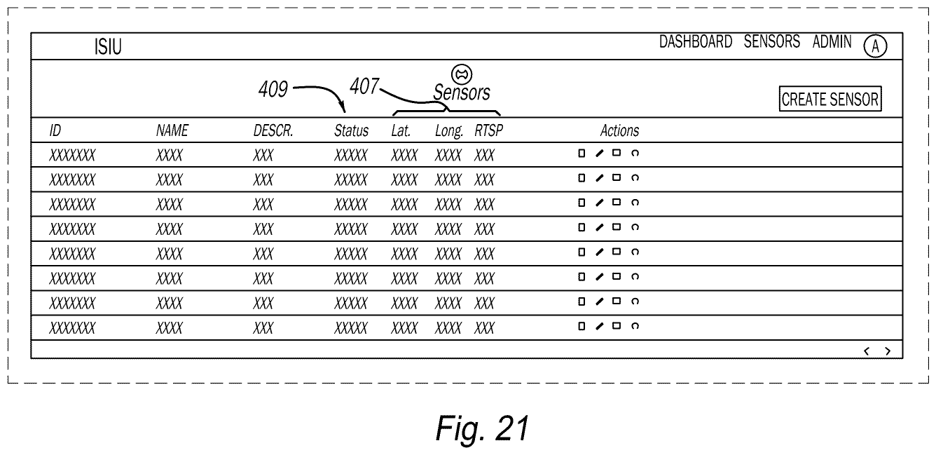

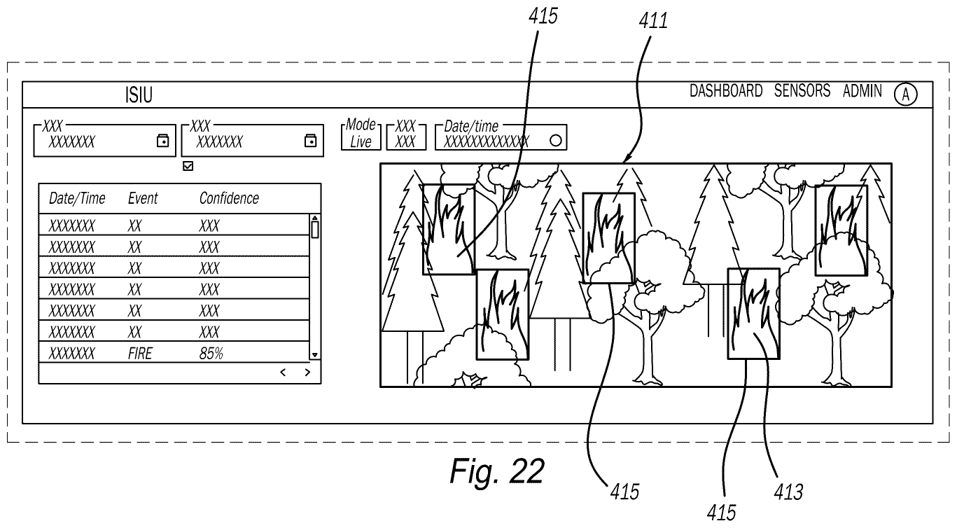

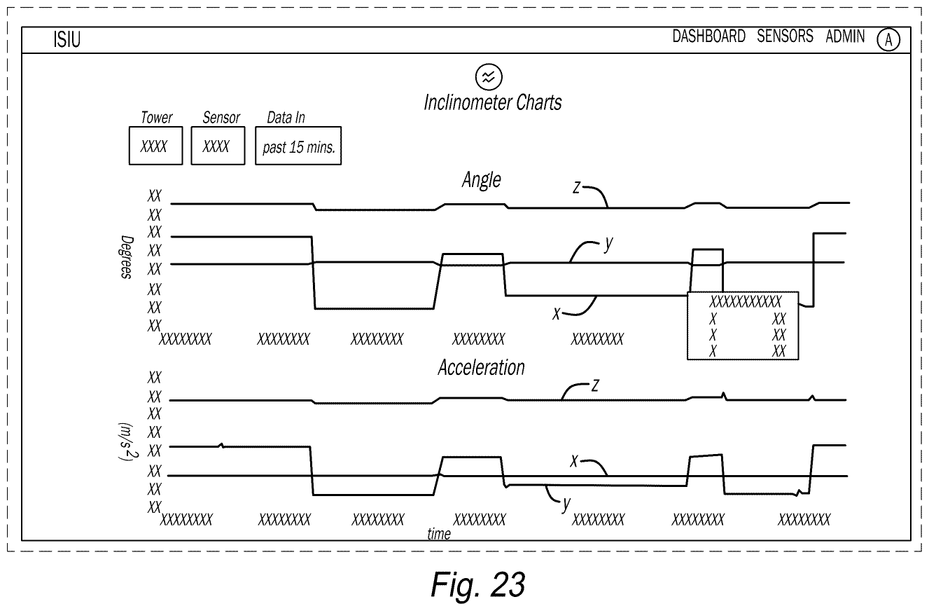

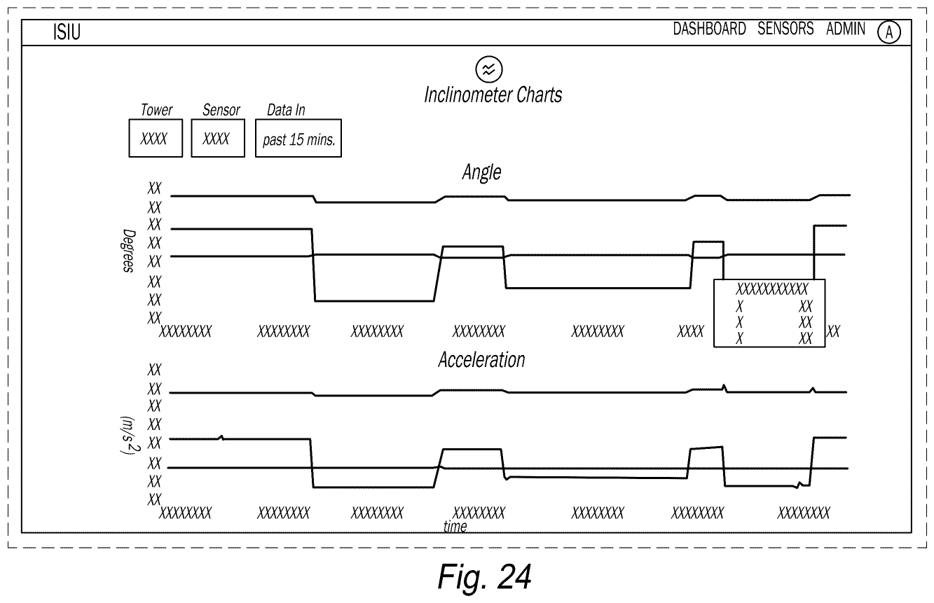

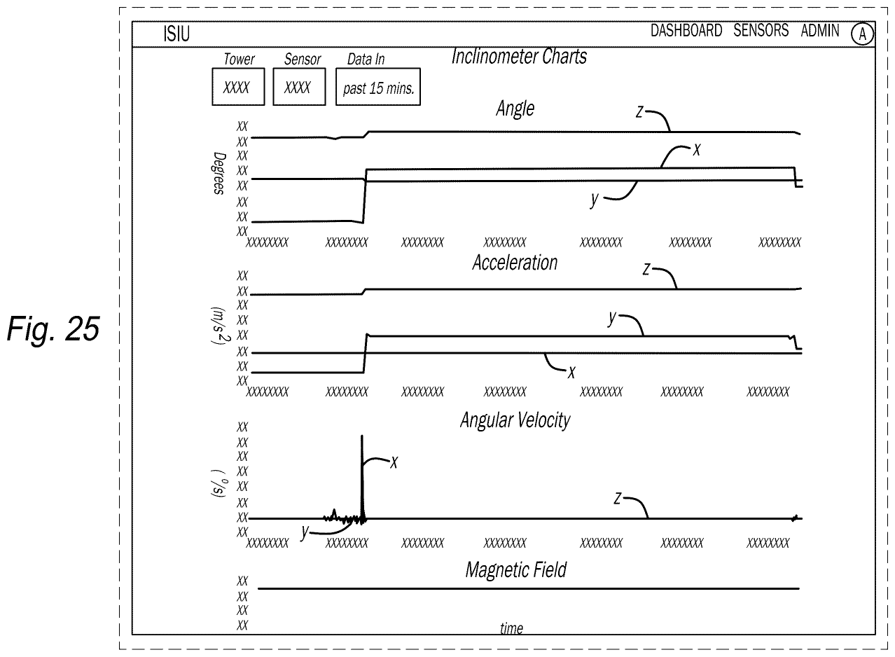

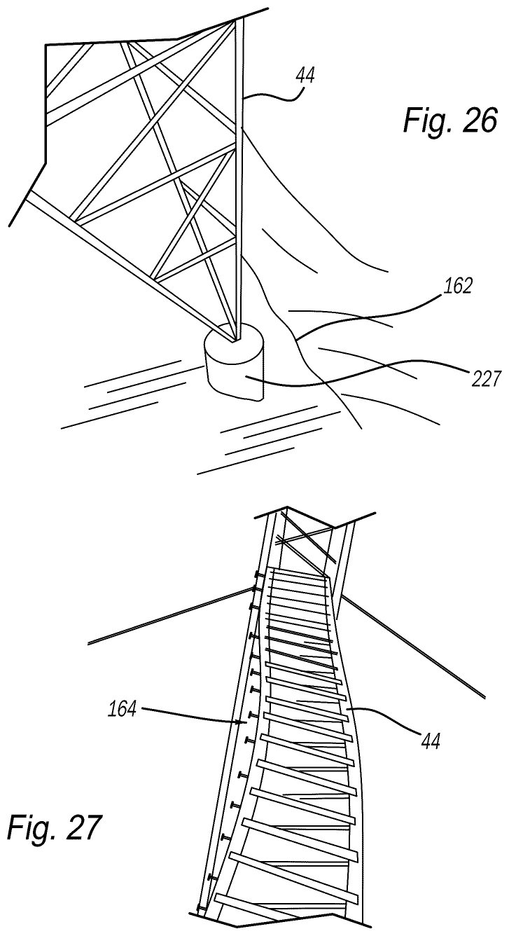

The software instruction and control logic method steps for the graphic user interface (“GUI”) displays for the central control center and/or remote PDAs, are shown in FIGS. 15 and 20-25, and described as follows:
A. Identify/input target area of interest.
B. Virtually display map 401 with IMU/camera monitoring locations 403 at central control station 405 (see FIG. 20).
C. Virtually display chart of coordinates 407 and status 409 of IMU/camera monitoring locations on a sensor list view (see FIG. 21).
D. Automatically detect IMU sensor abnormality at monitoring location(s)
E. Automatically obtain images 411 from camera(s) of the sensed data abnormality, such as a wild fire 413 at monitoring location(s), and annotate images by superimposing surrounding frames 415 with associated text (see FIG. 22).
F. Automatically send data from the sensors and the images to the central controller, matched to monitoring location(s).
G. Automatically determine and transmit confidence and date/time of data and hazardous event detected (see FIG. 22).
H. Virtually display chart with determinations matched to images (see FIG. 22).
I. Virtually display graphs/charts of sensed IMU data from inclinometer/accelerometer/magnetometer/other sensors (see FIG. 23 for overview, FIG. 24 for data details at a specific time, FIG. 25 for additional angular velocity and magnetic field parameters).
J. Automatically send alert to mobile PDAs.
K. Automatically activate countermeasures and/or remedial actions, which may be optionally displayed on a task list, work order and/or calendar.

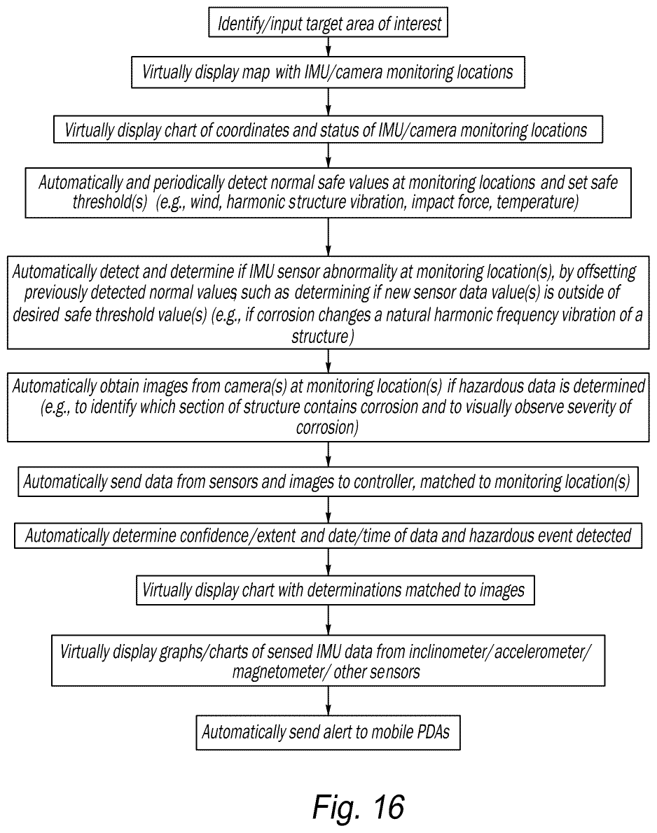

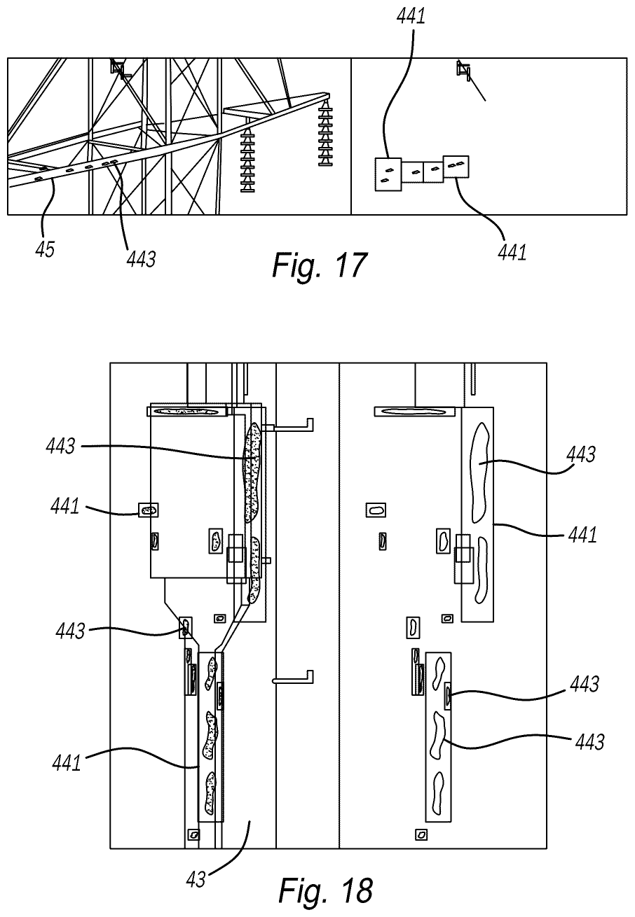

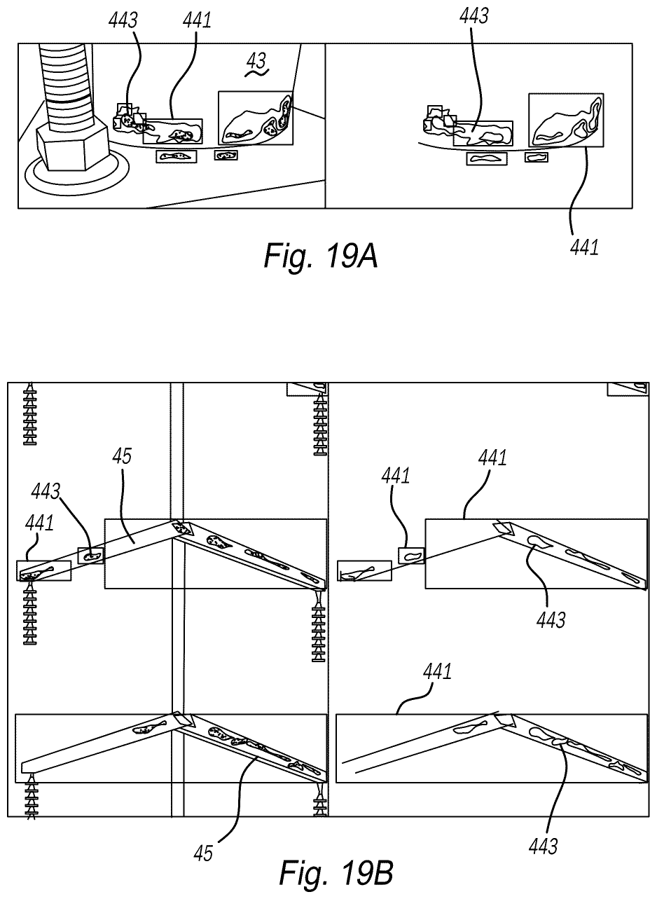

The software instruction and control logic method steps for automatic corrosion detection and reporting can be observed in FIGS. 16-19B, and are described as follows:
A. Identify/input target area of interest.
B. Virtually display a map with IMU/camera monitoring locations.
C. Virtually display a chart of coordinates and status of IMU/camera monitoring locations.
D. Automatically and periodically detect normal safe values at monitoring locations and set safe or nominal threshold(s) (e.g., normal and acceptable wind speed, harmonic structure vibration for fresh and uncorroded structural section, acceptable minor impact force, temperature, acceptable contraction and expansion movement).
E. Automatically detect and determine if there is IMU sensor data abnormality at the monitoring location(s), by offsetting previously detected normal values, such as determining if new sensor data value(s) is outside of desired safe threshold value(s); for example, if corrosion changes a natural harmonic frequency vibration of a structure.
F. Automatically obtain images from camera(s) at the monitoring location(s) where real-time sensed hazardous data is determined and annotate the images, to identify which section of structure contains corrosion and to visually observe severity of corrosion. Exemplary transmitted and displayed camera images, showing annotated frames 441 surrounding corrosion 443 on metallic electric tower crossarms 45 (see FIGS. 17 and 19B), on metal risers 445 on an electric pole 43 (see FIG. 18), and at a base of a metal electric pole 43 (see FIG. 19A).
G. Automatically send data from the IMU sensors and images to a central controller and/or remote user PDAs, matched to the monitoring location(s).
H. Automatically determine confidence/extent and date/time of data and hazardous event detected, and transmit the determination results to the central controller and/or remote user PDAs.
I. Virtually display chart with determinations matched to images.
J. Virtually display graphs/charts of sensed IMU data from the inclinometer/accelerometer/magnetometer/other sensors.
K. Automatically send alert to mobile PDAs.

Referring now to FIG. 29, an optional methane sensor 473 is coupled to the IMU housing and the IMU electrical circuit, to monitor methane emissions 471 in real-time adjacent to the structure. Methane is a highly potent greenhouse gas which predominately is emitted from naturally occurring biochemical processes such as marshes, wetlands and cow stomachs. By placing stationary methane sensors adjacent to these marsh, wetlands and dairy/meat farms, as well as natural gas pipelines and tanks, the present system can measure natural and man-made methane emissions. This includes sensing the presence of and amount of both carbon-12 (12C) and carbon-13 (13C).

Methane sensors 473 work in concert with on-site camera(s) 35, as automatically controlled by an on-site controller and its software instructions (like with the previously described examples), so that it's on-site controller can distinguish natural methane emissions from man-made emissions. The automatically activated PTZ camera 35, based on real-time sensed data and the controller's determinations, transmit remote visual confirmation of methane sources (natural or manmade) and emissions detection in-situ to central/cloud controller 163 and/or remote user PDAs 165, which provides significant advantages over traditional methods which require laboratory analysis. This system also beneficially monitors any abnormal increase in manmade methane emissions, such as from failure of pipelines and tanks in the event of natural disasters and other mechanical failures.

While various features of the present invention have been disclosed, it should be appreciated that other variations may be employed. For example, different or additional electronic components can be employed in the present electrical circuit, although various advantages of the present system may not be realized. As another example, alternate stationary structures may be monitored, but certain benefits may not be obtained. Additionally, alternate sensor constructions and locations can be employed although durability, performance, and cost may not be as beneficial as the preferred examples. Moreover, additional or different GUI displays and data therein can be used with the present system, but some advantages may not be obtained. While an on-site IMU controller and a single central/cloud controller have been described, this function can be divided among multiple controllers. Features of each of the embodiments and uses may be interchanged and replaced with similar features of other embodiments, and all of the claims may be multiply dependent on each other in any combination. Variations are not to be regarded as a departure from the present disclosure, and all such modifications are intended to be included within the scope and spirit of the present invention.

The invention claimed is:

1. A method of monitoring a structure, the method comprising:
(a) sensing a characteristic associated with the structure using at least one sensor;
(b) automatically determining if sensed data obtained by the sensor exceeds a threshold value with at least one programmable controller;
(c) automatically activating at least one camera at or adjacent to the structure to create an image of at least a portion of the structure or an area adjacent to the structure, when the controller determines that the sensed data exceeds the threshold value;
(d) the controller automatically sending at least some of the sensed data and the corresponding camera image to a remote receiver based on step (c); and
(e) the controller automatically sending a location of the sensor to the remote receiver based on step (c).

2. The method of claim 1, wherein the characteristic is indicative of corrosion, the sensed data is associated with a harmonic frequency of the structure, and the threshold value is associated with an uncorroded harmonic frequency of the structure.

3. The method of claim 2, wherein the at least one sensor includes an inertial measurement sensor, and the controller automatically sends a corrosion alert to the remote receiver which includes a handheld and portable digital display, and a stationary central control station with a display.

4. The method of claim 1, further comprising:
a photovoltaic panel;
a battery;
an antenna;
an electrical circuit connected to the photovoltaic panel, the battery and the antenna, the camera being connected to the electrical circuit;
the at least one sensor is part of an inertial measurement unit comprising an inclinometer and an accelerometer mounted within a housing;
the at least one camera being attached to the housing, the housing being mounted to the structure;
the inertial measurement unit and the at least one camera being connected to the photovoltaic panel, the battery and the electrical circuit; and
the at least one camera having multiple focal lengths to create multiples of the image with different magnification, and at different locations of the structure adjacent the inertial measurement unit.

5. The method of claim 1, further comprising:
a first photovoltaic panel;
a first battery;
a first antenna;
a first electrical circuit connected to the first photovoltaic panel, the first battery and the first antenna;
the at least one sensor is part of an inertial measurement unit comprising an inclinometer and an accelerometer mounted within a housing, the housing being mounted to the structure;
a second photovoltaic panel;
a second battery;
a second antenna;
a second electrical circuit connected to the second photovoltaic panel, the second battery and the second antenna;
the at least one camera being spaced away from but located adjacent to the housing; and
the at least one camera having multiple focal lengths to create multiples of the image with different magnification, and at different locations of the structure adjacent the inertial measurement unit.

6. The method of claim 1, wherein:
the structure is a high voltage power distribution tower;
the at least one sensor is part of an inertial measurement unit comprising an inclinometer and an accelerometer mounted within a housing, the housing being mounted to the tower;
the at least one camera is mounted to the tower; and
the sensor senses the characteristic which is at least one of: tower or powerline corrosion, mechanical tower support collapsing, breakage due to a tower surface irregularity, mechanical tower or powerline stress, mechanical tower or powerline strain, tower or powerline bending, tower or powerline twisting, tower or powerline scoliosis, or tower or powerline leaning.

7. The method of claim 1, wherein:
the structure is a high voltage power distribution tower;
the at least one sensor is part of an inertial measurement unit comprising an inclinometer and an accelerometer mounted within a housing, the housing being mounted to the tower;
the at least one camera is mounted to the tower; and
the sensor senses the characteristic which is at least one of: a wildfire adjacent to the tower or the powerline, smoke adjacent to the tower or the powerline, impact forces against the tower or the powerline, tower or powerline shaking or vibration, tower or powerline fluttering, tower or powerline aeroelastic buffeting, or tower or powerline galloping.

8. The method of claim 1, wherein:
the structure is a stationary pole with a powerline adjacent to the pole;
the at least one sensor is part of an inertial measurement unit comprising an inclinometer and an accelerometer mounted within a housing, the housing being mounted to the pole;
the at least one camera is mounted to the pole; and
the sensor senses the characteristic which is at least one of: pole or powerline corrosion, mechanical pole collapsing, breakage due to a pole surface irregularity, mechanical pole or powerline stress, mechanical pole or powerline strain, pole or powerline bending, pole or powerline twisting, pole or powerline scoliosis, or pole or powerline leaning.

9. The method of claim 1, wherein:
the structure is a stationary pole with a powerline adjacent to the pole;
the at least one sensor is part of an inertial measurement unit comprising an inclinometer and an accelerometer mounted within a housing, the housing being mounted to the pole;
the at least one camera is mounted to the pole; and
the sensor senses the characteristic which is at least one of: a wildfire adjacent to the pole or the powerline, smoke adjacent to the pole or the powerline, pole or powerline shaking or vibration, impact forces against the pole or the powerline, pole or powerline fluttering, pole or powerline aeroelastic buffeting, or pole or powerline galloping.

10. The method of claim 1, wherein:
the structure is a bridge, road or railway;
the at least one sensor is part of an inertial measurement unit comprising an inclinometer and an accelerometer mounted within a housing, the housing being mounted to the structure;
the at least one camera is mounted to a stationary bracket located on or adjacent to the structure; and
the sensor senses the characteristic which is at least one of: structure corrosion, mechanical structure collapsing, breakage due to a surface irregularity of the structure, mechanical stress of the structure, mechanical strain of the structure, bending of the structure, twisting of the structure, scoliosis of the structure, leaning of the structure, shaking or vibration of the structure, impact forces against the structure.

11. The method of claim 1, wherein:
the structure is a wind turbine, a stationary fluid holding tank, a stationary high rise building or a stationary communications tower;
the at least one sensor is part of an inertial measurement unit comprising an inclinometer and an accelerometer mounted within a housing, the housing being mounted to the structure;
the at least one camera is mounted on or adjacent to the structure; and
the sensor senses the characteristic which is at least one of: structure corrosion, mechanical structure collapsing, breakage due to a surface irregularity of the structure, mechanical stress of the structure, mechanical strain of the structure, bending of the structure, twisting of the structure, scoliosis of the structure, leaning of the structure, shaking or vibration of the structure, impact forces against the structure, a wildfire external to but adjacent to the structure, or smoke external to but adjacent to the structure.

12. The method of claim 1, wherein:
the structure is a ship or an aircraft;
the at least one sensor is part of an inertial measurement unit comprising an inclinometer and an accelerometer mounted within a housing, the housing being mounted to the structure;
the at least one camera is mounted to an external surface of the structure; and
the sensor senses the characteristic which is at least one of: structure corrosion, mechanical structure collapsing, breakage due to a surface irregularity of the structure, mechanical stress of the structure, mechanical strain of the structure, bending of the structure, twisting of the structure, scoliosis of the structure, leaning of the structure, shaking or vibration of the structure, impact forces against the structure.

13. The method of claim 1, wherein the at least one programmable controller causes a display to virtually show:
a map with locations of each unit comprising the at least one sensor and the at least one camera;
locational coordinates or an address, and a status of the at least one sensor and the at least one camera;
an image of the structure or an area adjacent to the structure obtained from the at least one camera including an annotated reference frame automatically added by the controller around an item of interest within the image;
the sensed data obtained from the at least one sensor including inclinometer angle information; and
a confidence or statistical determination output based at least in part on the sensed data.

14. The method of claim 1, wherein the at least one programmable controller automatically calculates at least one of: lean, drift and scoliosis, of a section of the structure based on the sensed data.

15. The method of claim 1, further comprising a methane sensor sending real-time sensed methane data at the structure, and the controller automatically causing the at least one camera to capture and transmit an image of a potential methane source to an end user along with the data.

16. A method of monitoring a structure, the method comprising:
(a) sensing a potential hazard associated with the structure, which is a powerline or a stationary powerline-supporting structure, using at least one sensor which is part of an inertial measurement unit comprising an inclinometer and an accelerometer mounted within a housing, the housing being stationary;
(b) automatically determining if sensed data obtained by the at least one sensor exceeds a threshold value;
(c) automatically causing at least one camera at or adjacent the structure to capture an image of at least a portion of or area adjacent to the structure, after it is determined that the sensed data exceeds the threshold value;
(d) automatically sending at least some of the sensed data and the corresponding camera image to a remote receiver; and
(e) the controller automatically sending a location of the sensor to the remote receiver; and
(f) the at least one sensor sensing and the camera image showing the potential hazard which is at least one of: corrosion, mechanical damage, undesired structure stress, undesired structure strain, undesired structure bending, undesired structure twisting, undesired structure scoliosis, undesired structure leaning, impact force, flood-induced movement of the structure, earthquake-induced movement of the structure, ground subsidence-induced movement of the structure, or ground erosion-induced movement of the structure.

17. The method of claim 16, wherein the potential hazard is corrosion, the sensed data is associated with a harmonic frequency of the structure, and the threshold value is associated with an uncorroded harmonic frequency of the structure.

18. The method of claim 16, further comprising an antenna coupled to the housing automatically sending a corrosion alert to the remote receiver which includes a handheld and portable digital display, and a stationary central control station with a display.

19. The method of claim 16, further comprising:
a photovoltaic panel;
placing a battery inside the housing;
coupling an antenna to the housing;
coupling the inertial measurement unit to the housing;
connecting an electrical circuit to the photovoltaic panel, the battery and the antenna;
connecting a controller and the camera to the electrical circuit;
the at least one sensor being connected to the electrical circuit;
attaching the at least one camera to the housing and connecting the at least one camera to the electrical circuit; and
creating multiples of the image with different magnification from the at least one camera.

20. The method of claim 16, further comprising:
a first photovoltaic panel;
placing a first battery within the housing
mounting the housing to the structure;
coupling a first antenna to the housing;
coupling the inertial measurement unit to the housing;
connecting a first electrical circuit to the first photovoltaic panel, the first battery, the first antenna and the at least one sensor;
a second photovoltaic panel;
placing a second battery within a second housing;
coupling a second antenna to the second housing;
connecting a second electrical circuit to the second photovoltaic panel, the second battery and the second antenna;
coupling the at least one camera to the second housing;
spacing the second housing away from but adjacent to the inertial measurement unit; and
creating multiples of the image with different magnification from the at least one camera.

21. The method of claim 16, further comprising at least one programmable controller causing a display to virtually show:
a map with a location of the inertial measurement unit;
locational coordinates or an address of the inertial measurement unit;
an image of the structure or an area adjacent to the structure obtained from the at least one camera including at least one reference frame around an item of interest within the image;
the sensed data obtained from the at least one sensor including inclinometer angle information; and
a confidence or statistical determination output based at least in part on the sensed data.

22. A method of monitoring a structure, the method comprising:
(a) sensing a characteristic associated with the structure using an angle, inertia, acceleration or vibration sensor, the sensor being coupled to a stationary section of the structure;
(b) automatically determining if sensed data obtained by the sensor exceeds a nominal angle, inertia, acceleration or vibration value with at least one programmable controller;
(c) automatically using at least one camera to transmit an image of at least a portion of the structure or an area adjacent to the structure, after the controller determines that the sensed data differs from the nominal value, the at least one camera being coupled to the section of the structure or a stationary surface adjacent to the structure;
(d) the at least one programmable controller causing a remotely located display to virtually show:
(i) a map with a location of the sensor;
(ii) locational coordinates or an address of the sensor;
(iii) an image of the structure or the area adjacent to the structure obtained from the at least one camera, the image being automatically annotated by the at lest one programmable controller; and
(iv) the sensed data obtained from the at least one sensor including angle, inertia, acceleration or vibration information.

23. The method of claim 22, wherein the characteristic is indicative of corrosion, the sensed data is associated with a harmonic frequency of the structure, and the nominal value is associated with an uncorroded harmonic frequency of the structure.

24. The method of claim 22, further comprising:
a photovoltaic panel;
placing a battery within a housing containing the sensor;
coupling an antenna to the housing; and
an electrical circuit connected to the photovoltaic panel, the battery, the antenna and the sensor.

25. The method of claim 22, wherein:
the structure is a powerline tower or pole;
mounting the sensor to the tower or pole, and stationarily mounting the at least one camera on or adjacent to the tower or pole; and
using the sensor to monitor the characteristic which is at least one of: tower or powerline corrosion, mechanical tower support damage, mechanical tower or powerline stress, mechanical tower or powerline strain, tower or powerline bending, tower or powerline twisting, tower or powerline scoliosis, tower or powerline leaning, impact force, flood-induced movement of the structure, earthquake-induced movement of the structure, ground subsidence-induced movement of the structure, ground erosion-induced movement of the structure, pole or powerline fluttering, pole or powerline aeroelastic buffeting, or pole or powerline galloping.

26. The method of claim 22, further comprising:
mounting the sensor to the structure which is a bridge, road or railway;
using the sensor to monitor the characteristic which is at least one of: tower or powerline corrosion, mechanical tower support damage, mechanical tower or powerline stress, mechanical tower or powerline strain, tower or powerline bending, tower or powerline twisting, tower or powerline scoliosis, tower or powerline leaning, impact force, flood-induced movement of the structure, earthquake-induced movement of the structure, ground subsidence-induced movement of the structure, ground erosion-induced movement of the structure, pole or powerline fluttering, pole or powerline aeroelastic buffeting, or pole or powerline galloping.

27. The method of claim 22, further comprising:
mounting the sensor to the structure which is a wind turbine, a stationary fluid holding tank, a stationary high rise building or a stationary communications tower;
mounting the at least one camera on or adjacent to the structure; and
using the sensor to monitor the characteristic which is at least one of: structure corrosion, mechanical structure collapsing, breakage due to a surface irregularity of the structure, mechanical stress of the structure, mechanical strain of the structure, bending of the structure, twisting of the structure, scoliosis of the structure, leaning of the structure, shaking or vibration of the structure, impact forces against the structure, a wildfire external to but adjacent to the structure, smoke external to but adjacent to the structure, flood-induced movement of the structure, earthquake-induced movement of the structure, ground subsidence-induced movement of the structure, ground erosion-induced movement of the structure.

28. The method of claim 22, further comprising:
mounting the sensor to the structure which is a ship or an aircraft;
mounting the at least one camera to an external surface of the structure; and
using the sensor to monitor the characteristic which is at least one of: structure corrosion, mechanical structure damage, breakage due to a surface irregularity of the structure, mechanical stress of the structure, mechanical strain of the structure, bending of the structure, twisting of the structure, scoliosis of the structure, undesired leaning of the structure, undesired shaking or vibration of the structure, or impact forces against the structure.

29. Structure-monitoring software, stored in non-transient memory, comprising:
(a) a first set of instructions receiving sensed data from at least one sensor associated with an angle, inertia, acceleration or vibration characteristic of a stationary structure;
(b) a second set of instructions automatically determining if the sensed data exceeds a threshold value;
(c) a third set of instructions automatically causing at least one camera at or adjacent the structure to capture an image of at least a portion of or area adjacent to the structure, after it is determined that the sensed data exceeds the threshold value;
(d) a fourth set of instructions automatically sending at least some of the sensed data and the corresponding camera image to a remote receiver; and
(e) a fifth set of instructions automatically sending a location of the at least one sensor to the remote receiver; and
(f) a sixth set of instructions causing a display to show the camera image which includes at least one of: corrosion on the structure, flood-induced movement of the structure, earthquake-induced movement of the structure, ground subsidence-induced movement of the structure, or ground erosion-induced movement of the structure.

30. The software of claim 29, wherein the camera image includes an automatically annotated reference frame around the corrosion on the structure.

31. The software of claim 29, wherein the sensed data is associated with a harmonic frequency of the structure when corroded, and the nominal value is associated with an uncorroded harmonic frequency of the structure.

32. The software of claim 29, wherein the structure is a powerline tower or a powerline pole, to which the sensor is stationarily mounted and to which the camera is mounted.

33. The software of claim 29, wherein the structure is a wind turbine or a stationary fluid holding tank, to which the sensor is stationarily mounted and to which the camera is mounted.

34. The software of claim 29, wherein the structure is a bridge, road or railway, to which the sensor is stationarily mounted.

35. The software of claim 29, further comprising additional programmed instructions causing the display to virtually show:
a map with a location of the sensor which is part of an inertial measurement unit;
locational coordinates or an address of the inertial measurement unit;
an image of the structure or an area adjacent to the structure obtained from the at least one camera;
the sensed data obtained from the at least one sensor including inclinometer angle information; and
a confidence or statistical determination output based at least in part on the sensed data.

36. The software of claim 29, further comprising additional programmed instructions automatically calculating lean, drift or scoliosis of the structure based on the sensed data.

37. A method of monitoring at a stationary structure, the method comprising:
(a) sensing methane or airborne particulates using at least one sensor mounted to the stationary structure;
(b) automatically determining if sensed data obtained by the sensor exceeds a threshold value with at least one programmable controller;
(c) automatically activating at least one camera at or adjacent to the structure to create an image of a potential source of the methane or airborne particulates, when the controller determines that the sensed data exceeds the threshold value;
(d) the controller automatically sending at least some of the sensed data and the corresponding camera image to a remote receiver based on step (c); and
(e) the controller automatically sending a location of the sensor to the remote receiver.

38. An apparatus for monitoring a structure, the apparatus comprising:
(a) an inertial measurement unit comprising at least an inclinometer and an accelerometer mounted within a housing, the housing being stationary mounted to the structure, the inertial measurement unit being configured to sense a potential hazard associated with the structure which is stationarily affixed to the ground;
(b) at least one programmable controller configured to automatically determine when sensed data obtained by the inertial measurement unit exceeds a nominal value;
(c) the at least one programmable controller configured to automatically cause at least one camera located at or adjacent to the structure to capture an image of at least a portion of or an area adjacent to the structure, after the at least one programmable controller determines that the sensed data differs from the nominal value;
(d) an antenna coupled to the inertial measurement unit;
(e) a battery coupled to the inertial measurement unit;
(f) a photovoltaic panel coupled to the inertial measurement unit;
(g) a remote receiver including a display;
(h) the at least one programmable controller being configured to automatically send at least some of the sensed data and the corresponding camera image to the remote receiver;
(e) the at least one programmable controller being configured to automatically send a location of the inertial measurement unit to the remote receiver; and
(f) the display showing the at least some of the sensed data and the camera image associated with at least one of: corrosion of the structure, mechanical damage to the structure, undesired structure stress, undesired structure strain, undesired structure bending, undesired structure twisting, undesired structure scoliosis, undesired structure leaning, impact force against the structure, flood-induced movement of the structure, earthquake-induced movement of the structure, ground subsidence-induced movement of the structure, ground erosion-induced movement of the structure, or rock slide-induced movement of the structure.
